(19) United States
(12) Patent Application Publication
(10) Pub. No.: US 2009/0110366 A1
(43) Pub. Date: Apr. 30, 2009

(54) IMAGE PROCESSING APPARATUS AND IMAGE PROCESSING METHOD, PROGRAM, AND RECORDING MEDIUM

(75) Inventors: Junichi Ogikubo, Kanagawa (JP); Keita Shirane, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/210,432

(22) Filed: Sep. 15, 2008

(30) Foreign Application Priority Data
Oct. 24, 2007 (JP) 2007-276769

(51) Int. Cl. G11B 27/00

(52) U.S. Cl. 386/52

(57) ABSTRACT

An image processing apparatus, includes: a reception unit adapted to receive a parameter in respective frames which constitute a motion picture image; a generation unit adapted to generate from the parameter received by the reception unit, trajectory information for drawing a trajectory where the parameter is used for a coordinate while the parameter is used for a spatial axis of a virtual space; and a display control unit adapted to display the trajectory within the virtual space on the basis of the trajectory information generated by the generation unit.

### CROSS REFERENCES TO RELATED APPLICATIONS

The present invention contains subject matter related to Japanese Patent Application JP 2007-276769 filed in the Japanese Patent Office on Oct. 24, 2007, the entire contents of which are incorporated herein by reference.

### BACKGROUND OF THE INVENTION

1. Field of the Invention

The present invention relates to an image processing apparatus and an image processing method, a program, and a recording medium. In particular, the invention relates to an image processing apparatus and an image processing method, a program, and a recording medium which are suitably used for a case of managing a plurality of motion picture images.

2. Description of the Related Art

Up to now, such a technology has been proposed that an image of a subject like a person, an object, or a scenery is captured by using an image pickup apparatus, and a captured still image or motion picture is compressed through the JPEG standard, the MPEG standard, or the like to be saved in a recording medium such as a built-in memory installed in the image pickup apparatus or a removal medium which can be detachably attached to the image pickup apparatus.

Then, by using, for example, a personal computer or the like, a user can collectively save (archive) the still image data or motion picture data saved in the recording medium in a large volume recording medium such as a hard disc drive or an optical drive. Furthermore, in recent years, due to a development of a network technology, a broadband line such as a high bandwidth line or a high speed line has been widely spread. The user utilizes such a broadband line so as to be able to send the still images having the large data amount via an electronic mail, post the images to a general web site or a diary type web site (Blog) which is operated and updated by a single person or a group of a few people or a motion picture sharing site, or the like, or send the images to a predetermined web server for recording.

In accordance with the above-mentioned various use modes, by using so-called image management software or the like, the user can manage a large number of still images and motion pictures saved in the large volume recording medium by performing a classification on the basis of the image pickup date and time, etc., for example, to facilitate the viewing and searching. Then, as occasion demands, the user can edit or search for the targeted still image and motion picture by using image editing software.

In addition, so-called program contents are also provided through terrestrial digital broadcasting, digital satellite broadcasting, or the like or through a network distribution, etc. The number of contents has been significantly increased in recent years along with a trend of multichannel broadcasts. By using, for example, a dedicated use set-top box, a personal computer to which dedicated use software is installed, or the like, the user obtains these program contents and records the program contents in the large volume recording medium such as the hard disc or the optical disc, and can view the program contents as occasion demands.

As described above, as the number of the still image data, the motion picture data, and the data related to the recorded program contents is increased, it is more difficult to search for particular data from among the large number of data. In view of the above, such a technology has been proposed related to a display mode which is easy for the user to understand with a satisfactory usability (for example, refer to International Patent Publication Nos. WO2000/033455, WO2000/033570, and WO2000/033572).

### SUMMARY OF THE INVENTION

As described above, in a case where a large number of contents are dealt with, for example, the same contents may be recorded redundantly.

For example, in a case where a recording and reproduction apparatus is used so that a program content related to a predetermined keyword is automatically recorded from the multichannel broadcasting programs, the rebroadcast program contents may be repeatedly recorded.

In addition, as a plurality of users arbitrarily upload motion pictures to the motion picture sharing site, a plurality of completely same contents are uploaded to the program sharing site in some cases.

Similarly to the above-mentioned situations, in a case where a plurality of the same contents exist, for example, if attribution information associated with contents such as the image pickup date and time, the recording date and time, and the category is not edited or deleted, it is easy to search for the same contents and delete the unnecessary data. However, if at least a part of the attribution information is edited or deleted, for example, it is not easy to search for these same contents.

In addition, up to now, a technology for easily searching for the matching contents by using characteristics of images themselves without using the attribution information has not been proposed. Even in a case where a complex parameter calculation or the like is used to search for the matching contents, although the contents are originally the identical contents, if one of the contents is, for example, converted in the image size, the resolution, or the like, or the contents are subjected to codec through different systems, at least a part of the image parameters takes different values. Therefore, it is not easy to search for these same contents even having the same substances.

Also, irrespective of a content owned by an individual or a content uploaded to the motion picture sharing site or the like, for example, in a case where only parts of the plurality of contents are extracted and regarded as one content data, even though a certain content is the same as the original content in substances, the contents are treated as different contents.

In addition, on the basis of such content data constructed by a part of certain content data or content data generated by extracting and editing parts of the plurality of content data, it is extremely difficult to search for the original content data which is the base for these pieces of the contents data.

For example, even when the user watching the content after the editing desires to watch the whole content which functions as the base of the components, it is not easy to search for the original content as described above. For example, at the time of the editing, if the recording address of content which functions as the base or metadata thereof or the like is recorded and previously built up for the preparation so that the search can be performed with use of the recording address or the metadata, it is possible to easily search for the original content data from content data composed from a part of the base content data or content data generated by extracting and editing a part of the plurality of content data. However, a technology of easily providing the user a relation between the already edited content data where such a built-up preparation has not been made and the original content data does not exist.

In addition, as described above, at the present day when a distribution of content data is facilitated, there is a fear that an illegal content with a copyright problem may be widely distributed.

For example, a motion picture which is not preferable in terms of copyright is uploaded to the motion picture sharing site or the like in some cases. The uploaded motion picture may be, as described above, only a part of the content with the problem or the contents after the editing, for example, which may be converted in the image size or the resolution or subjected to the codec through different systems. Therefore, the copyright management in the motion picture sharing site reluctantly depends on human wave tactics where people eventually watch those contents for checking.

To be more specific, in the coincidence check of the motion picture images, for example, images at the beginning of a file or at a scene change point are checked automatically, semi-automatically, or with eyes. A technology which enables the comparison about the whole of the plurality of contents at once has not been proposed up to now.

In addition, as described above, for various purposes, there are a demand of comparing substances in a plurality of contents and a demand of searching for contents having a full or partial match, but an interface which allows the user to instinctively recognize a coincidence rate of the mutual contents or the like has not been proposed up to now.

The present invention has been made in view of the above, and it is desirable to provide an interface which allows the user to instinctively recognize the coincidence rate of the mutual contents or the like in a case where the whole of the plurality of contents are compared with one other at once.

According to an embodiment of the present invention, there is provided an image processing apparatus, including: reception means adapted to receive a parameter in respective frames which constitute a motion picture image; generation means adapted to generate from the parameter received by the reception means, trajectory information for drawing a trajectory where the parameter is used for a coordinate while the parameter is used for a spatial axis of a virtual space; and display control means adapted to display the trajectory within the virtual space on the basis of the trajectory information generated by the generation means.

The image processing apparatus according to the embodiment of the present invention can further include: operation means adapted to receive an operation input from a user, in which on the basis of the operation input performed by the user which is input through the operation means, in a case where the parameter specification is changed, the generation means can newly generate the trajectory information while the newly specified parameter is used as a spatial axis of the virtual space.

The image processing apparatus according to the embodiment of the present invention can further include: image generation means adapted to generate a thumbnail image of a frame constituting the motion picture image; and control means adapted to assign a display flag to a part of a frame corresponding to a predetermined position of the trajectory of metadata in a case where an operation input for displaying the thumbnail image of the frame corresponding to the predetermined position of the trajectory displayed in the virtual space which is performed by the operation means is received, in which the display control means can display the thumbnail image generated by the image generation means on the predetermined position of the trajectory while following the display flag assigned by the control means.

The image processing apparatus according to the embodiment of the present invention can further include: control means adapted to assign, in a case where an operation input for selecting a trajectory through the operation means is received, a display flag to a part of a motion picture image corresponding to the selected trajectory, in which the display control means can display the selected trajectory so as to be distinguishable from another trajectory while following the display flag assigned by the control means.

The image processing apparatus according to the embodiment of the present invention can further include: control means adapted to assign, in a case where an operation input for selecting a trajectory through the operation means is received, a starting point flag and an ending point flag to a part of a frame corresponding to a starting point and a part of a frame corresponding to an end point in the selected area, respectively, in which the display control means can display the selected area so as to be distinguishable from another area while following the starting point flag and the ending point flag assigned by the control means.

The image processing apparatus according to the embodiment of the present invention can further include: image generation means adapted to generate a thumbnail image of a frame constituting the motion picture image, in which the generation means can generate display information for displaying the thumbnail image generated by the image generation means along a time line, and the display control means can display the thumbnail image along the time line on the basis of the display information generated by the generation means.

In the image processing apparatus according to the embodiment of the present invention, in a case where the operation input performed by a user which is input through the operation means is received, the display control means can display one of the trajectory in the virtual space and the thumbnail image along the time line.

The image processing apparatus according to the embodiment of the present invention can further include: control means adapted to assign, in a case where an operation input for selecting a trajectory through the operation means is received, a selection flag to a part of a motion picture image corresponding to the selected trajectory, in which the display control means can display the thumbnail image along the time line while following the selection flag assigned by the control means.

The image processing apparatus according to the embodiment of the present invention can further include: control means adapted to assign, in a case where an operation input for selecting a trajectory through the operation means is received, a starting point flag and an ending point flag to a part of a frame corresponding to a starting point and a part of a frame corresponding to an end point in the selected area, respectively, in which in a case where an operation input for displaying the thumbnail image along the time line through the operation means is received, the display control means can display the thumbnail image in a state where positions of the frames to which the starting point flag and the ending point flag are assigned are recognizable.

The image processing apparatus according to the embodiment of the present invention can further include: control means adapted to assign a thumbnail image display flag at a part of a frame corresponding to the position on the time line in a case where an operation input for selecting the position on the time line through the operation means is received from a user who makes a reference to the display of the thumbnail image along the time line, in which the image generation means can generate the thumbnail image of the frame corresponding to the position on the time line, and the display control means can display the thumbnail image generated by the image generation means at the position on the time line.

In the image processing apparatus according to the embodiment of the present invention, the parameter can include three different parameters, and the virtual space can be a three-dimensional space.

In the image processing apparatus according to the embodiment of the present invention, the parameter can include luminance.

According to an embodiment of the present invention, there is provided an image processing method, including the steps of: receiving a parameter in respective frames which constitute a motion picture image; generating from the received parameter, trajectory information for drawing a trajectory where the parameter is used for a coordinate while the parameter is used for a spatial axis of a virtual space; and displaying the trajectory within the virtual space on the basis of the generated trajectory information.

The network refers to a mechanism in which at least two apparatuses are connected, and information can be transmitted from a certain apparatus to another apparatus. The apparatuses which perform a communication via the network may be mutually independent apparatuses or internal blocks which constitute one apparatus.

In addition, the communication may be not only a wireless communication and a wired communication but also a communication in which the wireless communication and the wired communication are mixed, that is, the wireless communication may be performed in a certain zone and the wired communication may be performed in the other zone. Furthermore, the communication may also take such a configuration that the wired communication may be performed from a certain apparatus to another apparatus, and the wireless communication may be performed from the other apparatus to the certain apparatus.

The image processing apparatus may be an independent processing apparatus, or may also be an information processing apparatus, a recording and reproduction apparatus, or a block in which an image processing of a set-top box is performed.

As described above, according to the embodiment of the present invention, it is possible to display the information indicating the characteristics of the plurality of motion pictures on the predetermined display unit, in particular, it is possible to indicate the characteristics of the plurality of motion pictures as the trajectories in the virtual three-dimensional space in which the three types of parameters are set as the space axes.

### BRIEF DESCRIPTION OF THE DRAWINGS

FIG. 1 is a block diagram of a configuration of an image processing system including an image processing apparatus;

FIG. 2 is an explanatory diagram for describing a virtual three-dimensional space;

FIG. 3 is an explanatory diagram for describing trajectories drawn in the virtual three-dimensional space;

FIG. 4 is an explanatory diagram for describing the trajectories drawn in the virtual three-dimensional space;

FIG. 5 is an explanatory diagram for describing the trajectories drawn in the virtual three-dimensional space;

FIGS. 6A to 6G are explanatory diagrams for describing examples of three-dimensional space axes;

FIG. 7 is an explanatory diagram for describing the trajectories in which only luminance is different;

FIG. 8 is an explanatory diagram for describing the trajectories of edited contents;

FIG. 9 is an explanatory diagram for describing the trajectories in edit points;

FIG. 10 is an explanatory diagram for describing a selection of the trajectories;

FIG. 11 is an explanatory diagram for describing a selection of a range within the trajectories;

FIG. 12 is an explanatory diagram for describing a display of a motion picture image;

FIG. 13 is an explanatory diagram for describing a display of thumbnail images;

FIG. 14 is an explanatory diagram for describing the trajectories of thinned-out contents;

FIG. 15 is an explanatory diagram for describing a display in a time line mode;

FIG. 16 is an explanatory diagram for describing an addition of thumbnail images;

FIG. 17 is an explanatory diagram for describing a display of thinned-out images in the time line mode;

FIG. 18 is an explanatory diagram for describing a method of presenting common parts;

FIG. 19 is an explanatory diagram for describing a change of an underline;

FIG. 20 is an explanatory diagram for describing the change of the underline;

FIG. 21 is an explanatory diagram for describing a classification of contents;

FIG. 22 is a function block diagram for describing functions of the image processing apparatus;

FIG. 23 is a function block diagram of a metadata extraction unit in FIG. 22;

FIG. 24 is an explanatory diagram for describing a calculation of fineness information;

FIG. 25 is an explanatory diagram for describing motion detection;

FIG. 26 is an explanatory diagram for describing the motion detection;

FIG. 27 is a function block diagram of a frequency analysis unit in FIG. 23;

FIG. 28 is an explanatory diagram for describing an HLS space;

FIG. 29 illustrates a metadata example;

FIG. 30 is a flowchart for describing a GUI display processing for image recognition;

FIG. 31 is a flowchart for describing a trajectory mode execution processing;

FIG. 32 is a flowchart for describing the trajectory mode execution processing;

FIG. 33 is a flowchart for describing a time line mode execution processing; and

FIG. 34 is a flowchart for describing the time line mode execution processing.

### DESCRIPTION OF THE PREFERRED EMBODIMENTS

Hereinafter, embodiments of the present invention will be described with reference to the drawings.

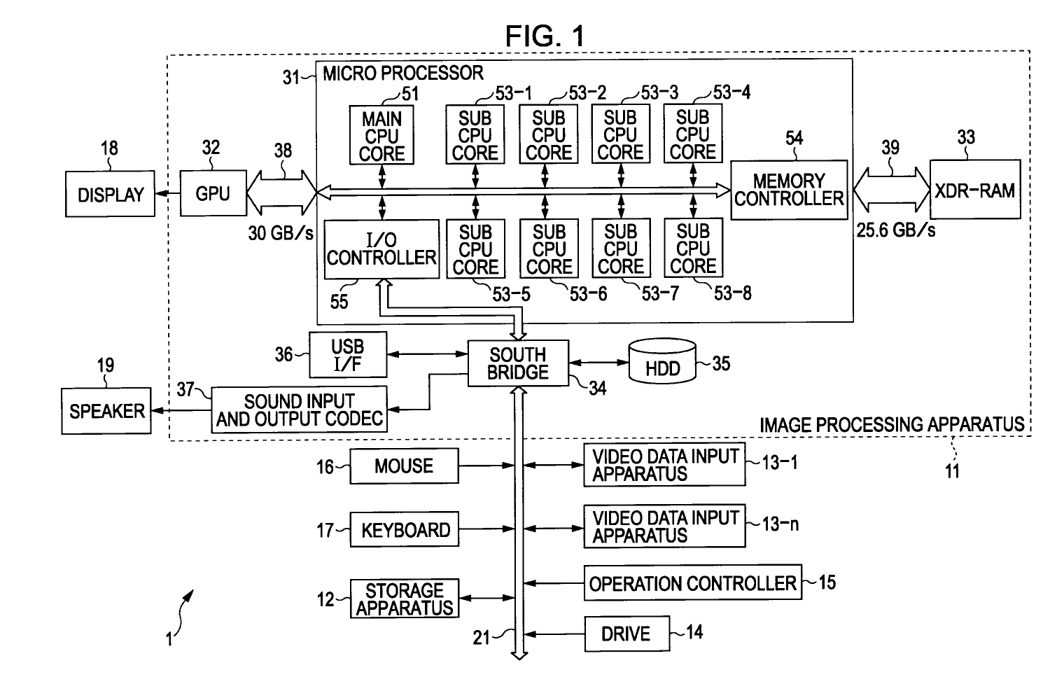

FIG. 1 illustrates an image processing system 1. The image processing system 1 is roughly composed of an image processing apparatus 11, and a storage apparatus 12, video data input apparatuses 13-1 to 13-n, a drive 14, an operation controller 15, a mouse 16, and a keyboard 17 which are connected via a PCI bus 21 to the image processing apparatus 11, and external apparatuses such as a display 18 and a speaker 19.

In the image processing system 1, motion picture contents recorded in the storage apparatus 12 or supplied via the video data input apparatuses 13-1 to 13-n or the drive 14 are analyzed, so that characteristic amounts thereof can be obtained. The characteristic amounts obtained as the result of the analysis can be registered as metadata. Also, in the image processing system 1, the metadata of the motion picture contents accumulated in the storage apparatus 12 or supplied via the video data input apparatuses 13-1 to 13-n or the drive 14 is used so as to be able to display a GUI (graphic user interface) which can display the characteristics of a plurality of motion picture contents. By making a reference to the displayed GUI, the user can find out a relation among the plurality of contents.

The image processing apparatus 11 is composed by including a micro processor 31, a GPU (Graphics Processing Unit) 32, an XDR (Extreme Data Rate)-RAN 33, a south bridge 34, a HDD 35, a USB interface 36, and a sound input and output codec 37.

In the image processing apparatus 11, the GPU 32, the XDR-RAM 33, and the south bridge 34 are connected to the micro processor 31a, and the HDD 35, the USB interface 36, and the sound input and output codec 37 are connected to the south bridge 34. The speaker 19 is connected to the sound input and output codec 37. Also, the display 18 is connected to the GPU 32.

In addition, the mouse 16, the keyboard 17, the storage apparatus 12, the video data input apparatuses 13-1 to 13-n, the drive 14, and the operation controller 15 are connected to the south bridge 34 via the PCI bus 21.

The operation controller 15, the mouse 16, and the keyboard 17 receive operation inputs from the user and supply signals indicating the contents of the operation inputs of the user to the micro processor 31 via the PCI bus 21 and the south bridge 34. The storage apparatus 12 is adapted to be able to record or reproduce predetermined data.

As the video data input apparatuses 13-1 to 13-n, for example, an interface which can exchange information with an external apparatus via a video tape recorder, an optical disc reproduction apparatus, the Internet, a LAN (local area network), or the like is used. The video data input apparatuses are adapted to obtain video data.

To the drive 14, removal media such as an optical disc and a semiconductor memory can be mounted. The drive 14 can read out information recorded in the removal media and record information in the removal media.

The micro processor 31 of the image processing apparatus 11 is composed of a multicore configuration in which a general use main CPU core 51 adapted to execute a program for instructing the image processing apparatus to execute a general use main CPU core 51 adapted to instruct the image processing apparatus to execute a basic program such as an OS (Operating System) and various processings, a plurality of (8 in this case) RISC (Reduced Instruction Set Computer) type signal processing processors (hereinafter, which will be referred to as sub CPU cores) 53-1 to 53-8 connected to the main CPU core 51 via an internal bus 52, a memory controller 54 adapted to perform a memory control on the XDR-RAM 33, and an I/O (In/Out) controller 55 adapted to manage input and output of data with the south bridge 34 are integrated on one chip. For example, the micro processor 31 realizes an operation frequency of 4 [GHz].

That is, at the time of activation, on the basis of the control program stored in the HDD 35, the micro processor 31 reads out a necessary application program stored in the HDD 35 to be expanded in the XDR-RAM 33. After that, on the basis of this application program and an operator operation, the micro processor 31 executes a necessary control processing.

The micro processor 31 plays a role of applying, for example, a codec processing such as MPEG (Moving Picture Expert Group), JPEG (Joint Photographic Experts Group) 2000, or H.264/AVC (Advanced Video Coding) on the supplied motion picture image or still image and is adapted to perform a physical computation or the like related to the codec processing. To be more specific, the micro processor 31 supplies an encoding stream obtained as a result of encoding the supplied uncompressed motion picture image or still image via the south bridge 34 to the HDD 35 to be stored and performs a data transfer of a reproduction video of the video or the still image obtained as a result of decoding the supplied compressed motion picture image or still image to the GPU 32, so that the reproduction video can be displayed on the display 18.

In particular, in the micro processor 31, the eight sub CPU cores 53-1 to 53-8 respectively play a role of an encoder constituting an encoder unit to encode baseband signals simultaneously in a parallel manner. Also, the eight sub CPU cores 53-1 to 53-8 respectively play a role of a decoder constituting a decoder unit to decode compressed image signals simultaneously in a parallel manner.

In this way, the micro processor 31 is configured to be able to execute the encode processing and the decode processing simultaneously in a parallel manner by using the eight sub CPU cores 53-1 to 53-8.

In addition, a part of the eight sub CPU cores 53-1 to 53-8 of the micro processor 31 can execute the encode processing and the other part can execute the decode processing simultaneously in a parallel manner.

In addition, for example, in a case where an independent encoder or decoder or a codec processing apparatus is connected to the PCI bus 21, the eight sub CPU cores 53-1 to 53-8 of the micro processor 31 can control a processing executed by the independent encoder or decoder or the codec processing apparatus via the south bridge 34 and the PCI bus 21. In a case where a plurality of independent encoders or decoders or the codec processing apparatuses are connected or a case where the independent encoder or decoder or the codec processing apparatus includes a plurality of decoders or encoders, the eight sub CPU cores 53-1 to 53-8 of the micro processor 31 can control processings executed by the plurality of decoders or encoders in a burden share manner.

In addition, the main CPU core 51 is adapted to perform other processing and management which are not performed by the eight sub CPU cores 53-1 to 53-8. Via the south bridge 34, the main CPU core 51 accepts commands supplied from the mouse 16, the keyboard 17, or the operation controller 15 and executes various processings in accordance with the commands.

In addition, the micro processor 31 extracts various parameters of the baseband signal or the encoding stream to be processed, and by using these parameters as metadata files, the micro processor 31 can also execute a processing of registering the metadata files via the south bridge 34 in the HDD 35.

In addition, on the basis of the extracted parameters, the micro processor 31 calculates information necessary to such a display on the GUI display screen that the user can instinctively perform a comparison about the whole of the plurality of contents to be supplied to the GPU 32.

That is, in order to provide such a user interface that the user can instinctively recognize coincident rates of the mutual contents or the like in a case of performing the comparison about the whole of the plurality of contents at once, the image processing apparatus 11 has two GUI display modes including a trajectory mode and a time line mode. The micro processor 31 executes various computations to generate GUI display screens corresponding to the two modes including the trajectory mode and the time line mode, and supplies the result to the GPU 32. The display screens in the two modes including the trajectory mode and the time line mode will be described below.

In addition, as the micro processor 31 performs an audio mixing processing on audio data among video data and audio data of the motion picture content and sends the thus obtained edited audio data via the south bridge 34 and the sound input and output codec 37 to the speaker 19, the audio based on the audio signal may also be output from the speaker 19.

In addition, the micro processor 31 is connected to the GPU 32 via a bus 38 having a large bandwidth and may perform the data transfer, for example, at a transfer speed of 30 [Gbyte/Sec] at maximum.

Under the control of the micro processor 31, the GPU 32 performs a predetermined processing on the video content of the motion picture content supplied from the micro processor 31, the image data of the still image content, or the information for displaying the GUI display screen, and sends the thus obtained video data or image data to the display 18, thus displaying the image signal on the display 18.

That is, the GPU 32 governs functions of performing, in addition to a final rendering processing related to a patching of texture displayed on the display 18, for example, at the time of moving the reproduction video of the motion picture content, a coordination conversion calculation processing for displaying a plurality of a part of the respective frame images constituting the reproduction video of the motion picture content on the display 18 at once, a magnification and reduction processing on the reproduction video of the motion picture content or the still image of the still image content, and the like. The GPU 32 is designed to reduce the processing burden of the micro processor 31.

The XDR-RAM 33 is a memory having, for example, a volume of 256 [MByte]. The XDR-RAM 33 is connected to the memory controller 54 of the micro processor 31 via a bus 39 having a large bandwidth, and may perform the data transfer at the transfer speed, for example, of 25.6 [Gbyte/Sec] at maximum.

The south bridge 34 is connected to the I/O controller 55 of the micro processor 31 and exchanges the information between the micro processor 31 and the HDD 35, the USB interface 36, and the sound input and output codec 37.

The HDD 35 is a storage unit having a large volume, which is composed of a hard disc drive. The HDD 35 can store, for example, a basic program, a control program, an application program, and the like, and also can store information necessary to execute these programs, parameters, and the like. In addition, the HDD 35 stores the above-mentioned metadata.

The USB interface 36 is an input and output interface for a connection with an external apparatus through a USB connection.

The sound input and output codec 37 decodes the audio data supplied via the south bridge 34 through a predetermined method and supplies the data to the speaker 19 for the audio output.

Next, the two modes including the trajectory mode and the time line mode will be described.

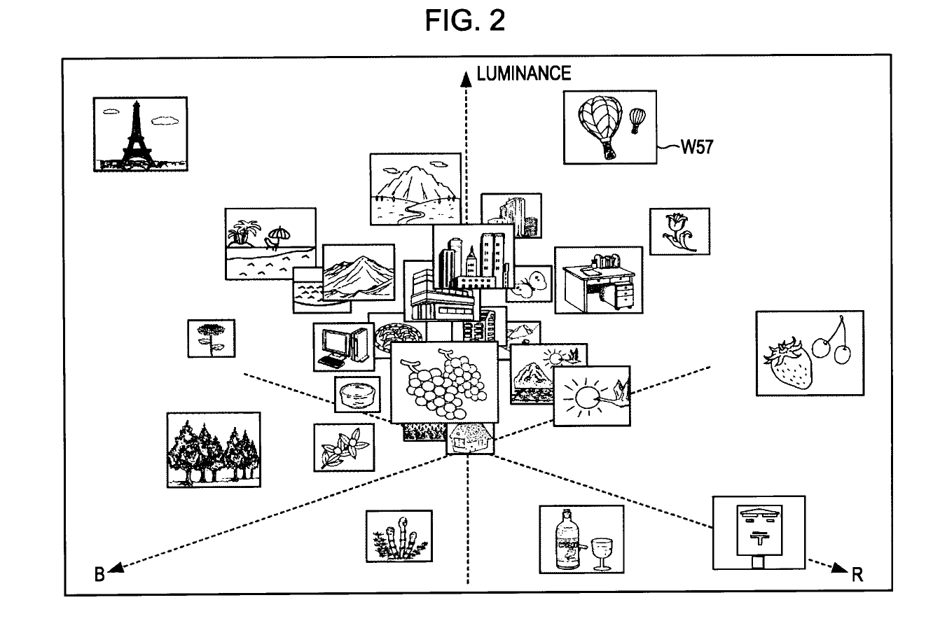

First, with reference to FIGS. 2 to 14, a display of a trajectory mode will be described.

For example, as illustrated in FIG. 2, in a virtual three-dimensional display space in which the X axis indicates “Red (R)”, the Y axis indicates “Blue (B)”, and the Z axis indicates “Luminance” for the parameters of the display axis, the still image data of one still image or the frame image data constituting the motion picture image can be position at one position on the basis of the characteristic amounts thereof.

It should be noted that in the three-dimensional display space illustrated in FIG. 2, a range limit only in the plus direction from the origin is used as to red in the X axis, blue in the Y axis, and the luminance in the Z axis, but the X axis, the Y axis, and the Z axis may also be displayed while including the minus direction from the origin.

As illustrated in FIG. 2, in the three-dimensional display space, the X axis indicates R, the Y axis indicates B, and the Z axis indicates the luminance as the parameters. Pictures at a high red level contained in the video data are arranged in a lower right direction of the screen. Also, pictures at a strong luminance level contained in the video data are arranged in an upper middle direction of the screen. Also, pictures at a high blue level contained in the video data are arranged in a lower left direction of the screen. With this configuration, the user who checks a plurality of video data pieces is allowed to instinctively recognize a rough tendency (distribution) of brightness or color components included in the plurality of video data pieces as an image.

The parameters constituting the respective display axes (the X axis, the Y axis, and the Z axis) in this three-dimensional display space are characteristic amounts indicating the characteristics of the video data constituting the content. Basically, the characteristic amounts vary for each picture constituting the video data unless the picture of the same still image continues in terms of time.

Then, in the motion picture image data constituted by the plurality of pictures having the above-mentioned characteristic amounts, except for a particular situation where the image is not changed over a plurality of frames, the characteristic amounts basically vary depending on the frame. Thus, the coordinate of the characteristic amounts for each frame of the motion picture image data floats in such a three-dimensional display space.

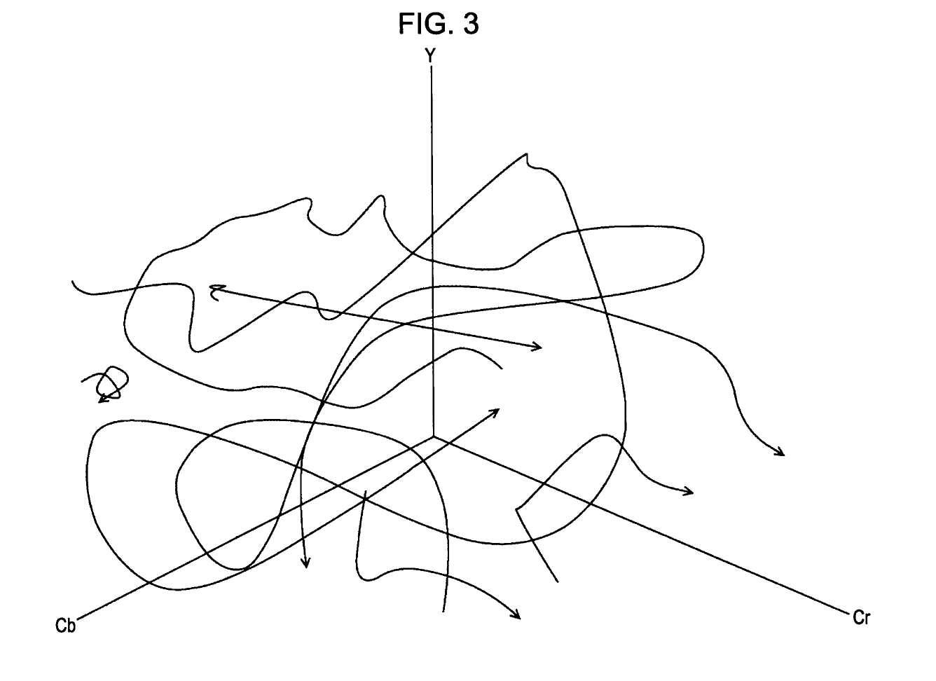

FIG. 3 illustrates an example of trajectories of a plurality of contents which are drawn by following the characteristic amounts for each frame of a plurality of motion picture image data pieces in the three-dimensional display space where the X axis represents Cr, the Y axis represents Cb, and the Z axis represents a luminance Y as parameters.

The micro processor 31 of the image processing apparatus 11 obtains, for example, one or a plurality of contents selected by the user making a reference to a clip list display screen (not shown) which is a list of content data recorded in the storage apparatus 12 or supplied via the video data input apparatuses 13-1 to 13-n or the drive 14, from the storage apparatus 12, the video data input apparatuses 13-1 to 13-n, or the drive 14. Then, when metadata composed of the characteristic amounts used for the above-mentioned three-dimensional space coordinate is assigned to the thus obtained content, the micro processor 31 registers the metadata in the HDD 35. When the metadata is not assigned to the content, the metadata is computed to be registered in the HDD 35.

Then, the micro processor 31 decodes the content when necessary, and also reads out the metadata corresponding to the contents from the HDD 35 to execute a necessary computation for drawing the trajectory of the set three-dimensional space coordinate and supply this information to the GPU 32. On the basis of the information supplied from the micro processor 31, the GPU 32 displays the three-dimensional space trajectories illustrated in FIG. 3 on the display 18.

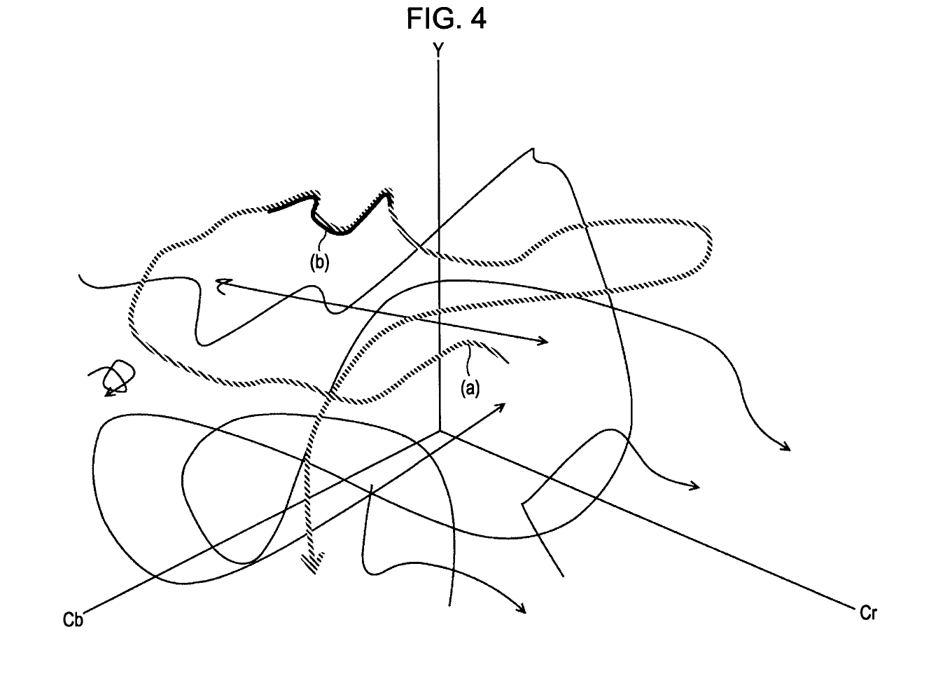

For example, in a case where trajectories illustrated in FIG. 4 are displayed, in a content “a” corresponding to a trajectory (a) and a content “b” corresponding to a trajectory (b) which partially matches the trajectory (a), it is possible to easily suppose that the content b is extracted from a part of the content a.

It should be noted that the case illustrated in FIG. 4 is synonymous with a case where only the comparison in the three parameters constituting the three-dimensional space is performed. In view of the above, the setting of the three parameters constituting the three-dimensional space is changed, and a three-dimensional space in different three-dimensional axes can be displayed.

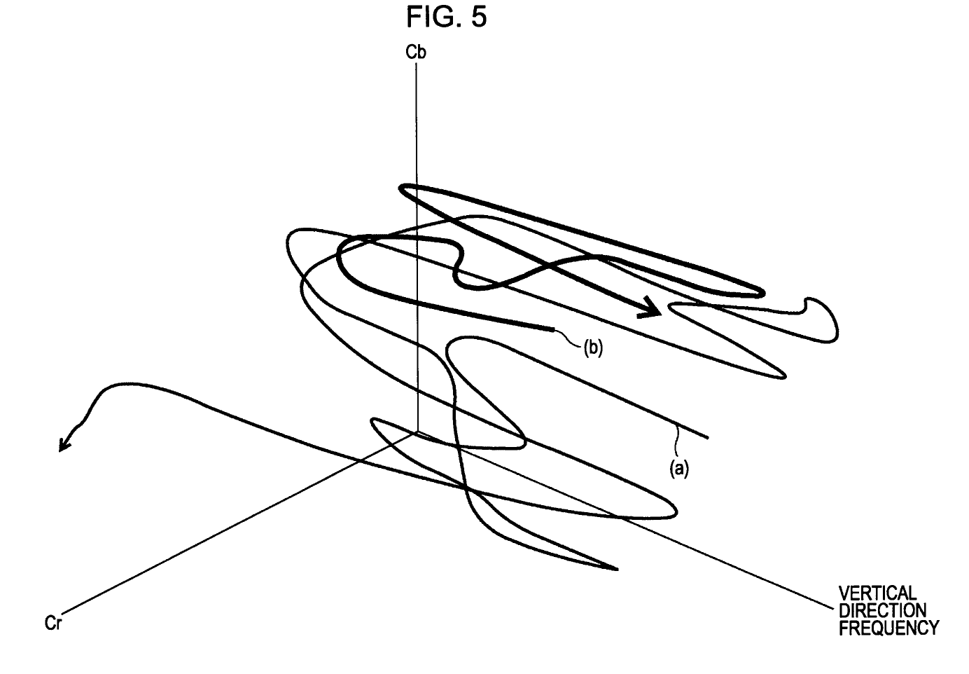

For example, in a case where the user uses the operation controller 15, the mouse 16, or the like to instruct that the setting of the three parameters constituting the three-dimensional space is changed from the luminance Y axis, the Cb axis, and the Cr axis illustrated in FIG. 4 to the Cb axis, the Cr axis, and a DCT (Discrete cosine Transform) vertical direction frequency axis, on the basis of the signal corresponding to the operation input performed by the user which is supplied via the south bridge 34, the micro processor 31 executes a necessary computation to draw a trajectory of the newly set three-dimensional space coordinate of the Cb axis, the Cr axis, and the DCT vertical direction frequency axis and supplies this information to the GPU 32. On the basis of the information supplied from the micro processor 31, the GPU 32 displays the Cb axis, the Cr axis, three-dimensional space trajectories of the DCT vertical direction frequency axis illustrated in FIG. 5 are displayed on the display 18.

In this manner, as the result of changing the axes of the displayed three-dimensional space coordinate, in a case where the trajectory (a) and the trajectory (b) illustrated in FIG. 4 have no correlation, the user can suppose that the content a and the content b are different contents from each other.

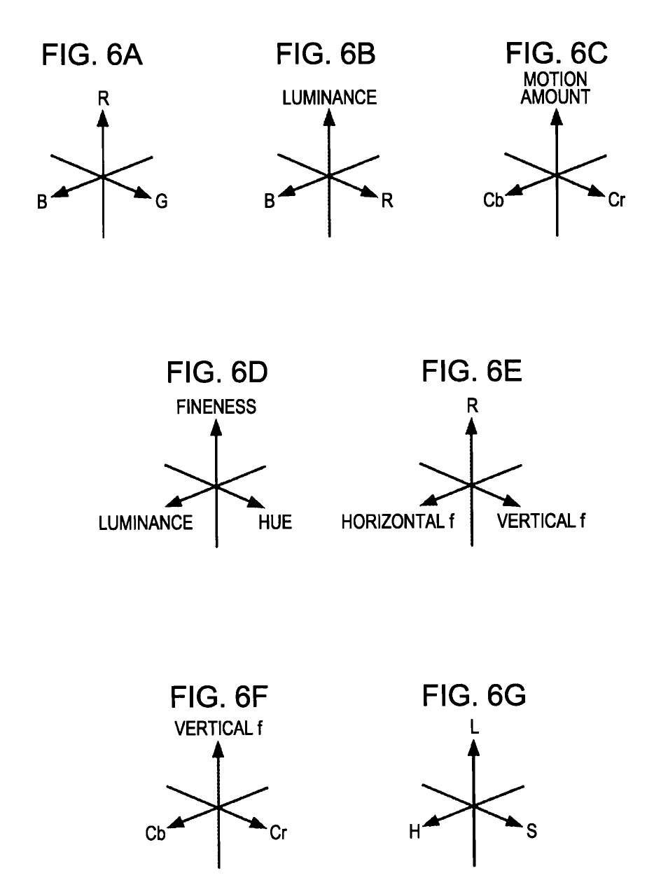

Herein, the micro processor 31 of the image processing apparatus 11 can decide the respective display axes so that, for example, as illustrated in FIG. 6A, the three-dimensional display space composed of the R axis, the G axis, and the B axis representing the respective color components of RGB, as illustrated in FIG. 6B, the three-dimensional display space composed of the luminance level axis, the R axis, and the B axis, as illustrated in FIG. 6C, the three-dimensional display space composed of the motion amount axis, the Cb axis, and the Cr axis, as illustrated in FIG. 6D, the three-dimensional display space composed of the fineness information axis, the luminance level axis, and the hue axis, as illustrated in FIG. 6E, the three-dimensional display space composed of the R axis, the DCT vertical frequency axis, and the DCT horizontal frequency axis, as illustrated in FIG. 6F, the three-dimensional display space composed of the DCT vertical frequency axis, the Cb axis, and the Cr axis, as illustrated in FIG. 6G, the three-dimensional display space composed of the L (Luminance) axis, the H (Hue) axis, and the S (Saturation) axis which are the respective components of the HLS space, and the like are generated. It should be noted that the characteristic amounts registered in the metadata file, that is, the parameters which function as the axes of the three-dimensional space are not limited to the above-mentioned examples, but the parameters can be decided so that the three-dimensional display space in which various characteristic parameters registered in the metadata file are set as the display axes are generated.

To be more specific, for example, by using the three-dimensional display space composed of the parameter axis representing the fineness of the frame image, the parameter axis representing the magnitude of the motion, and the luminance Y axis, the three-dimensional display space composed of the parameter axis representing the color dispersion, the DCT vertical frequency axis, and the DCT horizontal frequency axis, the three-dimensional display space composed of the parameter axis representing the fineness of the frame image, the H (Hue) axis, and the S (Saturation) axis, the three-dimensional display space composed of the parameter axis representing the coincidence rate with respect to a face of a certain person, the Cb axis, and the Cr axis, and the like, it is possible to draw the trajectory representing the characteristic amounts of the motion picture image.

Herein, the coincidence rate with respect to a face of a certain person can be obtained, for example, by using a technology described in Japanese Unexamined Patent Application Publication No. 2006-4003. The coincidence rate of a predetermined face with respect to faces appearing in the respective frames is calculated by using such a technology, and the value (for example, 0% to 100%) can be set as the parameter for a certain axis on the three-dimensional space.

In addition, in video data obtained through a spy camera on a film projected in a cinema, a part around a screen, heads of viewers, and the like appear in black in the picture frame. Therefore, in a case where the three parameters constituting the three-dimensional space includes the luminance, the original video data and the video data obtained through the spy camera have almost the same parameter values for the two contents other than the luminance. However, the video data obtained through the spy camera has more black parts, and only the luminance component draws the low trajectory.

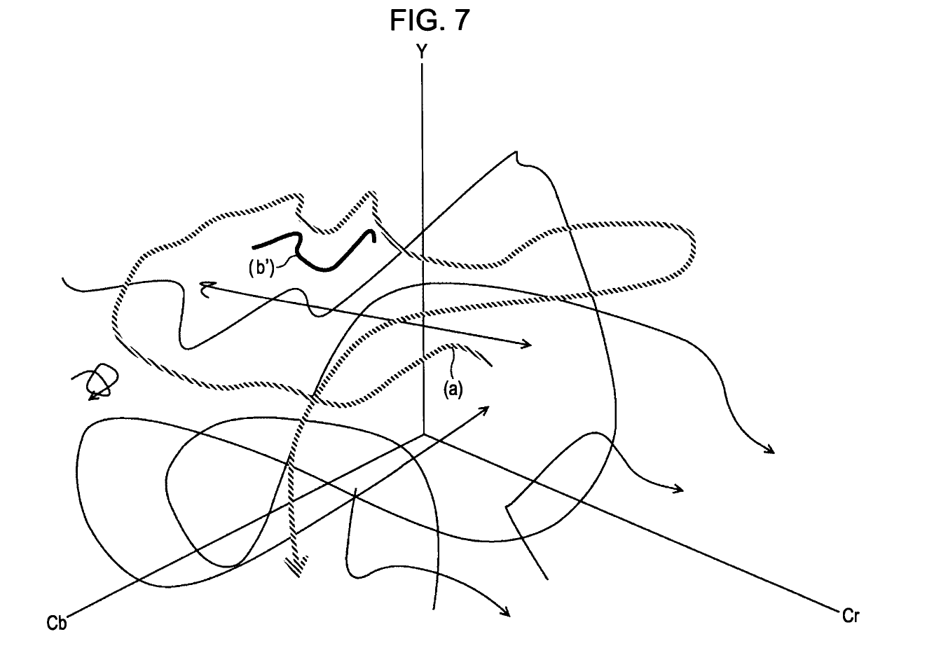

Therefore, in the case illustrated in FIG. 7, it is possible to suppose that the content b is a content having the relevance to the content a. For example, the content b is an extraction of a part of data obtained through the spy camera on the content a in the cinema.

In addition, similarly, in a case where the three parameters constituting the three-dimensional space includes the luminance, when a frame in white or a color close to white is provided, these pieces of video data have almost the same parameter values for the contents other than the luminance. However, the video data provided with the frame has more white parts, and such a situation may be generated that only the luminance component draws the high trajectory.

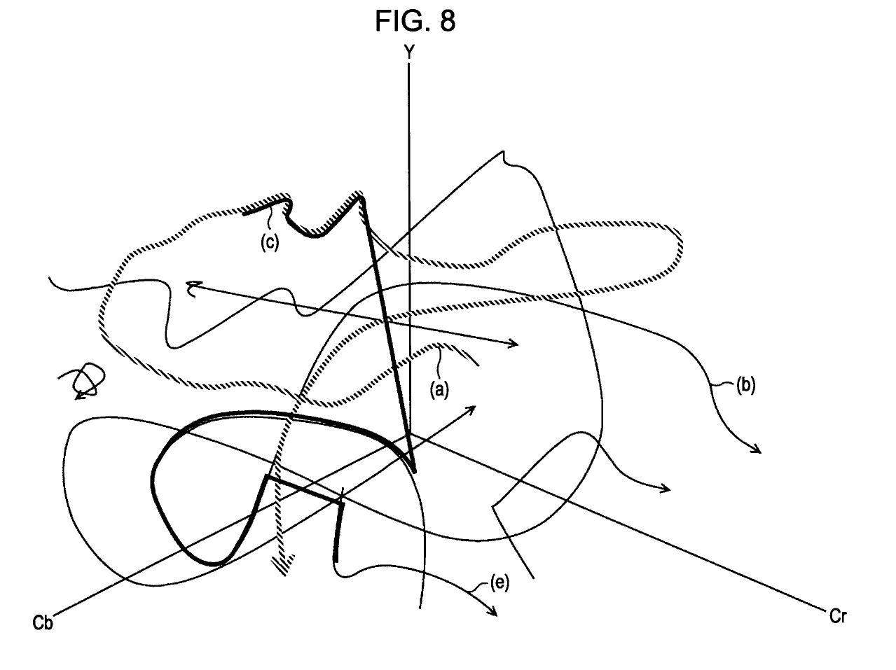

In addition, the edited content constituted by a part of the plurality of contents has the same trajectory as or the trajectory in parallel with a part of the trajectories of the plurality of contents. To be more specific, as illustrated in FIG. 8, a content (c) is composed by including a part of a content (a), a part of a content (d), and a part of a content (e).

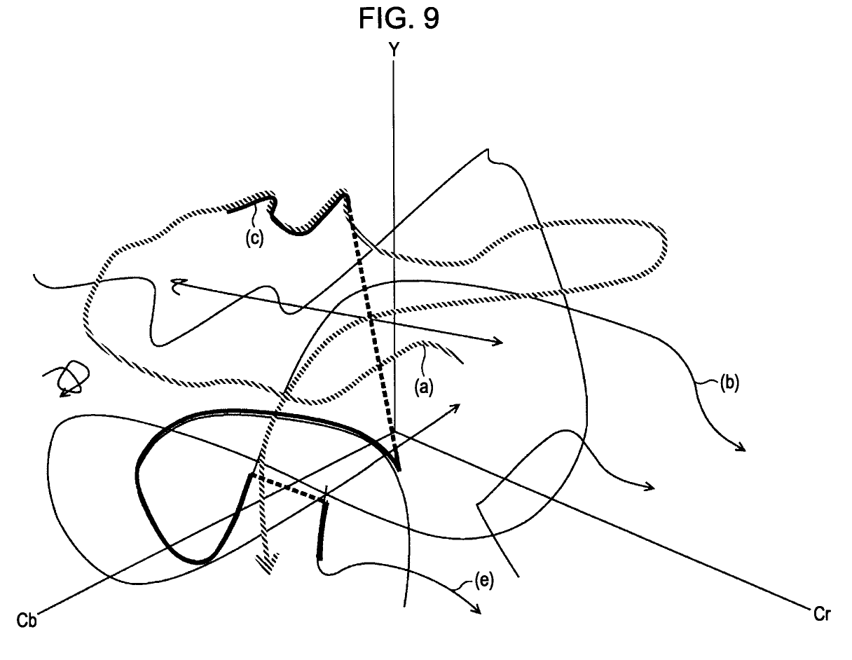

It should be noted that before and after a scene change generated at a part where contents are connected to each other during the editing or the like, the characteristic amounts do not have continuity in the above-mentioned three-dimensional space. In view of the above, two coordinates having no continuity before and after the scene change can be connected to each other by a straight line on these three-dimensional spaces. Then, in a part having no scene change where the charateristic amounts are gradually changed and a part where the charateristic amounts are largely changed due to the scene change, the display of those trajectories may be set distinguishable by using the solid line and the dotted line, for example, as illustrated in FIG. 9.

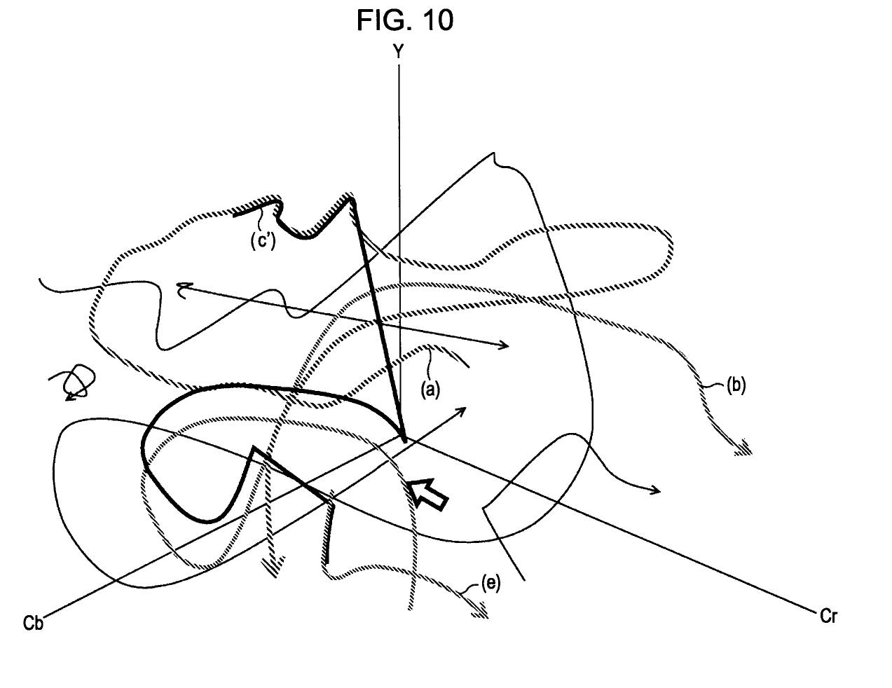

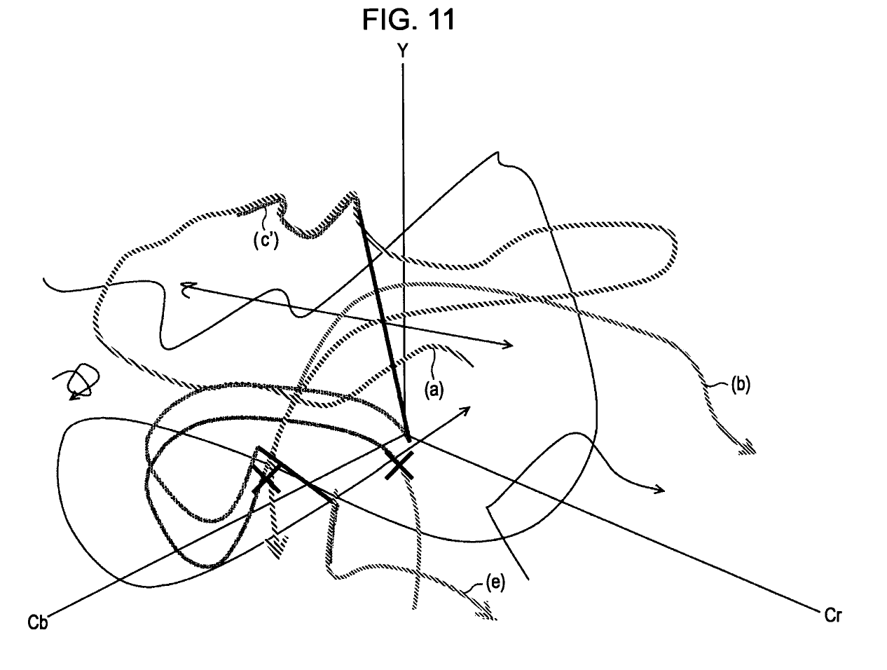

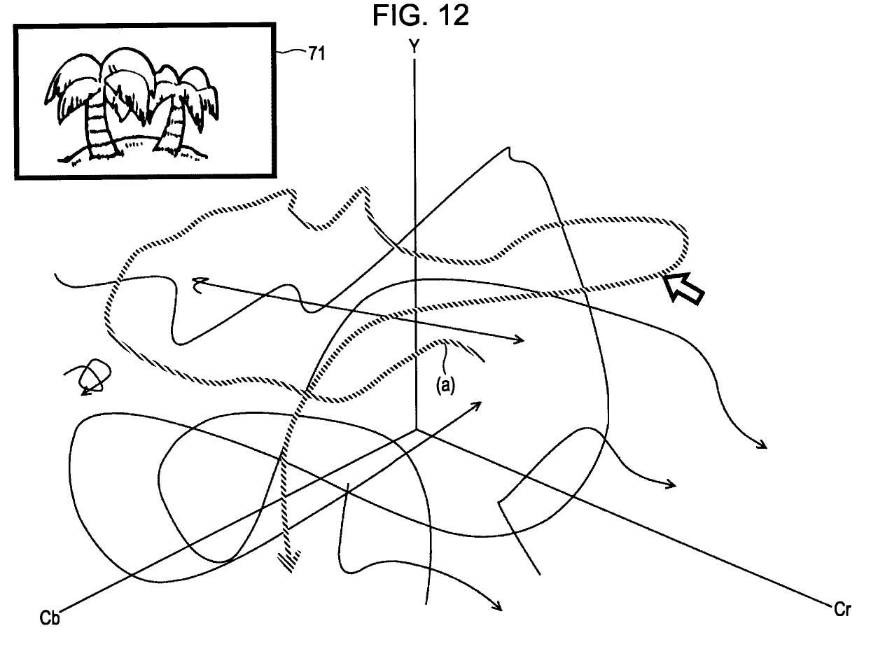

In addition, as illustrated in FIG. 10, a part of an edited content (c′) draws substantially the same trajectory as the content (a) and the content (e) in a certain three-dimensional coordinate system (herein, a three-dimensional coordinate system composed of the Cb axis, the Cr axis, and the Y axis), but the other part is a trajectory shifted in parallel in the luminance direction with respect to the trajectory of the content (d) as described by using FIG. 7. In this manner, the edited content is not only matching the trajectory of the original content, but also the edited content may be a part of which is a trajectory having the relevance in some cases. In such a case, when the coordinate in the displayed three-dimensional space is changed, the user desires to grasp the respective corresponding trajectories as they are, and in addition, on the display screen where a large number of trajectories are displayed, it is desirable to easily distinguish the matching trajectories and the trajectories having the relevance from other trajectories. In view of the above, in the image processing apparatus 11, it is desirable, as illustrated in FIG. 10, that a plurality of trajectories selected by the user can be displayed in highlight or displayed in different colors. With this configuration, for example, with respect to the certain edited content, it is possible to distinguish the content supposed to be the material of the edited content from other contents for the display.

At this time, on the basis of the operation input performed by the user which is supplied from the operation controller 15, the mouse 16, or the keyboard 17, the micro processor 31 assigns selection content flag to the metadata of the content specified by the user. Then, the micro processor 31 computes data for displaying the trajectory of the content corresponding to the metadata to which the selection content flag is assigned in highlight or in a different color and supplies the data to the GPU 32. On the basis of the information supplied from the micro processor 31, as illustrated in FIG. 10, the GPU 32 displays the GUI display screen where the trajectory selected by the user is displayed in highlight or in a different color on the display 18.

In addition, in the image processing apparatus 11, it is possible to select and display only one content as an attention content so as to be distinguishable from other selected contents. To be more specific, for example, it is possible to display the trajectory of the content (c′) illustrated in FIG. 10 as the attention content so as to be further distinguished from other selected contents.

At this time, on the basis of the operation input performed by the user which is supplied from the operation controller 15, the mouse 16, or the keyboard 17, the micro processor 31 assigns the attention content flag to the metadata of the content which is specified as the attention content. Then, the micro processor 31 computes data for displaying the trajectory of the content corresponding to the metadata to which the attention content flag is assigned in highlight or in a different color through a display method with which the content can be distinguished from the selection contents and supplies the data to the GPU 32. On the basis of the information supplied from the micro processor 31, the GPU 32 displays the GUI display screen where the trajectory corresponding to the attention content selected by the user is displayed so as to be distinguishable from the other selection contents on the display 18.

In addition, in the image processing apparatus 11, while referring to the GUI display screen, it is possible for the user to select only parts where it is supposed that the substances in two or more contents are matched with each other and to display the parts to be distinguishable from the other parts. To be more specific, when the user selects a starting point and an ending point of the part supposed to be matching on the displayed three-dimensional coordinate, for example, which are represented by a cross mark (x) in FIG. 11, the trajectory between the starting point and the ending point is displayed so as to be distinguishable from the other parts.

At that time, on the basis of the operation input performed by the user which is supplied from the operation controller 15, the mouse 16, or the keyboard 17, the micro processor 31 obtains the coordinates of the starting point and the ending point of the content selected by the user. Then, on the basis of the coordinates, the micro processor 31 obtains information such as frame numbers corresponding to the starting point and the ending point of the content, or corresponding frame reproduction time (for example, a relative time from the starting position of the relevant content) and assigns a starting point flag and an ending point flag to the frames of the corresponding metadata. Also, the micro processor 31 computes data for displaying the trajectory between the starting point and the ending point so as to be distinguishable from the other parts and supplies the data to the GPU 32. The GPU 32 displays the GUI display screen where the trajectory between the starting point and the ending point specified by the user is displayed so as to be distinguished from the other parts on the display 18 on the basis of the information supplied from the micro processor 31.

In addition, after it is set that the substances are matched with each other in the different contents in the time line mode which will be described later, in a case where the trajectory mode is executed, the parts set as having the matching substances are automatically displayed in such a manner that the trajectory between the starting point and the ending point is displayed so as to be distinguishable from the other parts.

That is, the micro processor 31 extracts the frames to which the starting point flag and the ending point flag are assigned from the metadata registered in the HDD 35, and computes coordinates of the frames to which the starting point flag and the ending point flag are assigned in such a manner that the trajectory between those frames is displayed so as to be distinguishable from the other parts to be supplied to the GPU 32. The GPU 32 displays the GUI display screen where, for example, the trajectory between the starting point and the ending point specified by the user is displayed in a different color or in a different line type so as to be distinguishable from the other parts on the display 18 on the basis of the information supplied from the micro processor 31.

In addition, the GPU 32 also receives the supply of decoded content data from the micro processor 31. Thus, in the trajectory mode, it is also possible to display the content data together with the trajectory of the above-mentioned three-dimensional space. For example, as illustrated in FIG. 12, a separate window 71 for displaying the content corresponding to the trajectory selected by the user together with the three-dimensional space is provided, and the separate window 71 may reproduce and display the content data corresponding to the selected trajectory.

In addition, in the reproduction of the content data executed in the image processing apparatus 11, a reproduction starting point may be set from a predetermined point on the trajectory. That is, on the basis of the metadata of the corresponding content, the micro processor 31 executes a necessary computation to draw the trajectory of the set three-dimensional space coordinate, and thus, the micro processor 31 recognizes that the respective points of the trajectory correspond to which points of the reproduction times of the respective pieces of content data. In a case where, by using the operation controller 15, the mouse 16, or the like, the user selects a predetermined coordinate on the trajectory of the three-dimensional space coordinate, the micro processor 31 finds out, on the basis of the signal corresponding to the operation input performed by the user which is supplied via the south bridge 34, the reproduction starting point of the content data corresponding to the coordinate selected by the user, and supplies the decoded data from the corresponding part to the GPU 32. By using the decoded data supplied from the micro processor 31, as illustrated in FIG. 12, the GPU 32 reproduces and displays the content data corresponding to the selected trajectory from the frame corresponding to the coordinate specified by the user on the separate window 71 in the display 18.

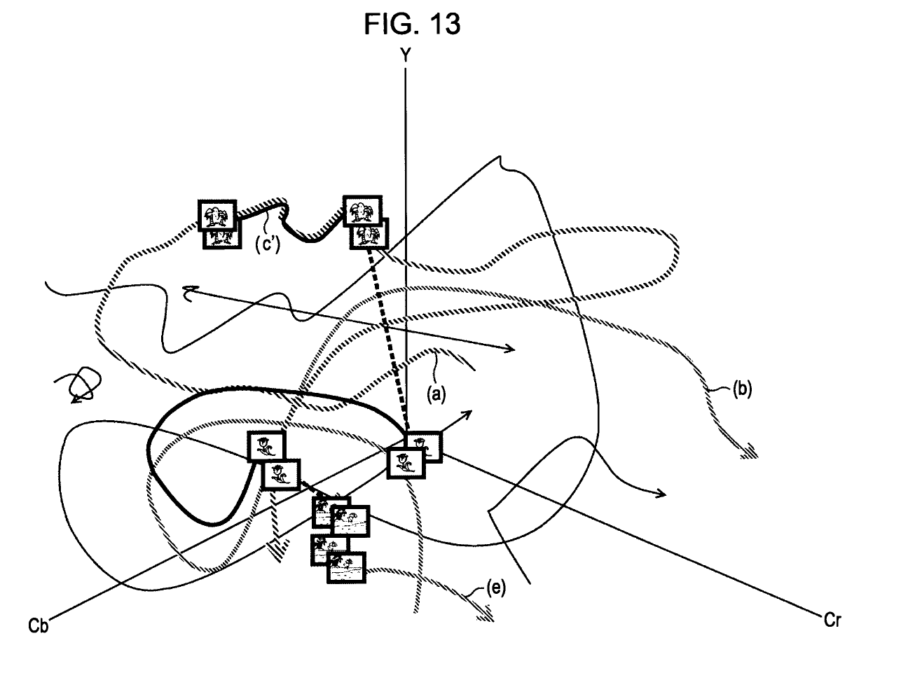

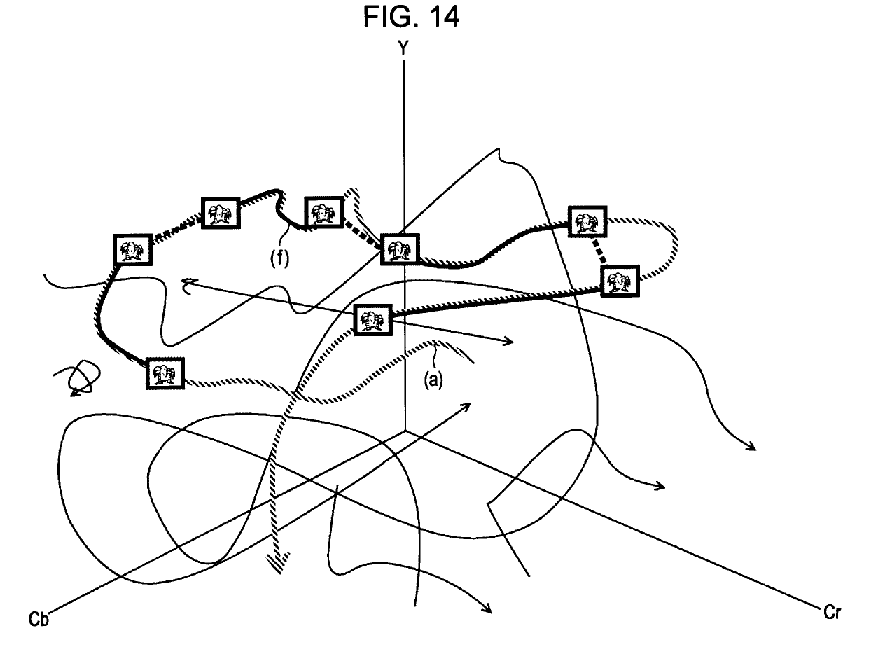

In addition, in the trajectory mode executed in the image processing apparatus 11, it is possible to display the thumbnail images corresponding to the respective frame images constituting the content data at the corresponding positions on the trajectory. For example, by displaying a starting frame of the content data, the user may easily recognize the relevance between the trajectory and the content. Also, as the micro processor 31 recognizes that the respective points of the trajectory correspond to which points of the reproduction times of the respective content data, in a case where the user selects a predetermined coordination on the trajectory on the three-dimensional space coordinate by using the operation controller 15, the mouse 16, or the like, the micro processor 31 extracts the frame image data corresponding to the coordinate selected by the user on the basis of the signal corresponding to the operation input performed by the user which is supplied via the south bridge 34 and supplies the frame image data to the GPU 32. The GPU 32 displays the thumbnail images on the predetermined coordinate on the trajectory displayed on the display 18 on the basis of the information supplied from the micro processor 31, as illustrated in FIG. 13.

As the user instructs display of the thumbnail images corresponding to the starting point and the ending point, etc., in which it is supposed that the substances are matched with each other among a plurality of trajectories, for example, it is possible to confirm whether or not those substances are matched with each other without checking all the frames.

At this time, with respect to the metadata of the corresponding content, the micro processor 31 assigns a thumbnail image display flag at the part of the frame corresponding to the frame image data which corresponds to the coordinate specified by the user on the basis of the operation input performed by the user which is supplied from the operation controller 15 or the mouse 16 via the south bridge 34.

In addition, in a case where the user instructs the cancellation of the display of the already displayed thumbnail images, with respect to the metadata of the corresponding content, on the basis of the operation input performed by the user which is supplied from the operation controller 15 or the mouse 16 via the south bridge 34, the micro processor 31 deletes the thumbnail image display flag for the frame corresponding to the frame image data which corresponds to the coordinate specified by the user and also generates information for canceling the display of the thumbnail images to be supplied to the GPU 32. The GPU 32 cancels the display of the thumbnail images specified by the user on the basis of the information supplied from the micro processor 31.

In this manner, by displaying the thumbnail images corresponding to the frame image data at the user's desired position, the user can recognize whether or not the substances of the corresponding two trajectories are actually matched with each other. In addition, in a case where the substances of the corresponding two trajectories are actually matched with each other, the user can recognize which parts are matched with each other.

In addition, the trajectory mode means the trajectories on the three-dimensional space composed of the characteristic amounts of the respective frames are compared without the relation with the time axis. For example, as illustrated in FIG. 14, like a case where the content (a) which is originally the continuous motion picture and a content (f) indicated by the solid line in the drawing which is obtained by intermittently deleting frames from the content (a) so as to shorten the reproduction time are displayed on the three-dimensional space, for example, even in a case where the similarity is difficult to find out through the comparison of the continuity of the characteristic amounts obtained for each frame, by comparing the displayed trajectories, it is possible to easily recognize the relation between these contents.

In this manner, in the trajectory mode, the correlation among the plurality of contents can be recognized without the relation with the time axis. However, in particular, in a case where the scene change is generated, for example, as the visible length of the trajectory is not matched with the actual content length, it is difficult to find out the positional relation between the time axis and the respective scenes in those individual contents. Also, in the trajectory mode, even when it is possible to recognize that a certain content is matched with a part of a certain content, it is difficult to understand which part in the respective contents is matched with which part of the other content as the time axis is not apparent.

In contrast to this, in the time line mode, the time axis is set and the plurality of contents are displayed on the basis of the same time axis.

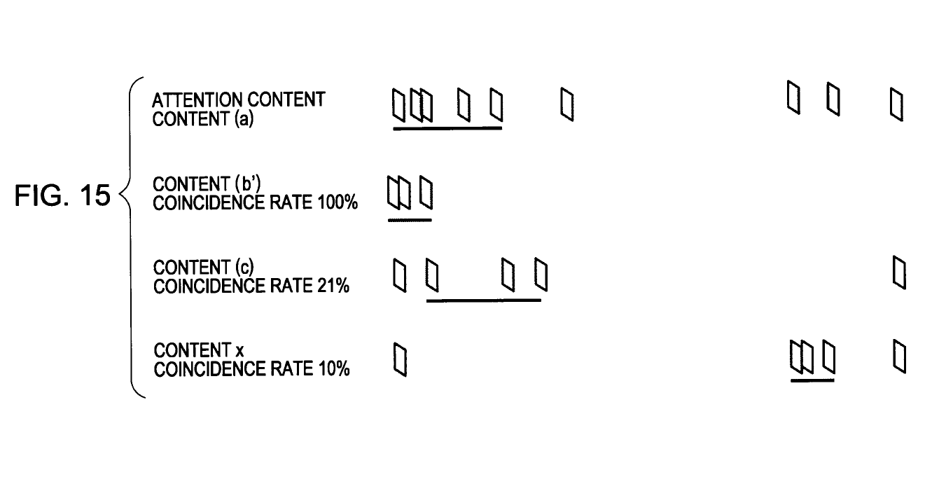

Next, with reference to FIGS. 15 to 21, the time line mode will be described.

Basically, the time line mode means the selection contents and the attention content selected by the user in the trajectory mode are displayed on the same time axis. It should be noted that the time axis is preferably set by using the content having the longest time among the display target contents as a reference.

For example, such a case will be described in which the attention content is set as the content (a) which is illustrated in FIG. 4 or the like in the above-mentioned trajectory mode, a part of the plurality of contents such as the content (b′) illustrated in FIG. 7, the content (c) illustrated in FIG. 8 or the like, and a content x which is not shown in the above-mentioned drawings is supposed to be matched with the content (a) and selected as the selection contents, and the user instructs the time line mode in a state where the starting point and the ending point of the matching part is set.

The micro processor 31 of the image processing apparatus 11 extracts the metadata of the content to which the attention content flag is assigned and the metadata to which the selection content flag is assigned from the metadata registered in the HDD 35. Then, from the extracted metadata, the micro processor 31 extracts the frame numbers of the frames to which the starting point flag and the ending point flag are assigned and the image data of the frames as well as the frames to which the thumbnail image display flag is assigned, and the frame numbers and the image data of the starting frame and the ending frame of the contents. For example, as illustrated in FIG. 15, on the same time line while the starting times of the attention content and the other contents are used as the reference, the thumbnail images in the starting frame and the ending frame of the respective contents, the thumbnail images in the starting point frame and the ending point frame of the parts supposed to be matched with each other in the trajectory mode, and the thumbnail images displayed in the trajectory mode are displayed, and data for underline the parts recognized to be matched with each other is computed and supplied to the GPU 32. The GPU 32 displays the GUI display screen illustrated in FIG. 15 on the display 18 on the basis of the information supplied from the micro processor 31. Herein, a part of the content (a) which is the attention content matches a part of other displayed contents.

In addition, the micro processor 31 calculates the number of frames in the supposedly matching interval on the basis of the frames to which the starting point flag and the ending point flag are assigned and computes the coincidence rate of the other selected contents to the attention content. The micro processor 31 supplies the data to the GPU 32 so as to be displayed on the GUI display screen illustrated in FIG. 15.

In addition, by increasing the number of the thumbnail images displayed in the time line mode, it is possible to more instinctively grasp from which positions to which position the attention content and the selection contents are matched with each other with certainty.

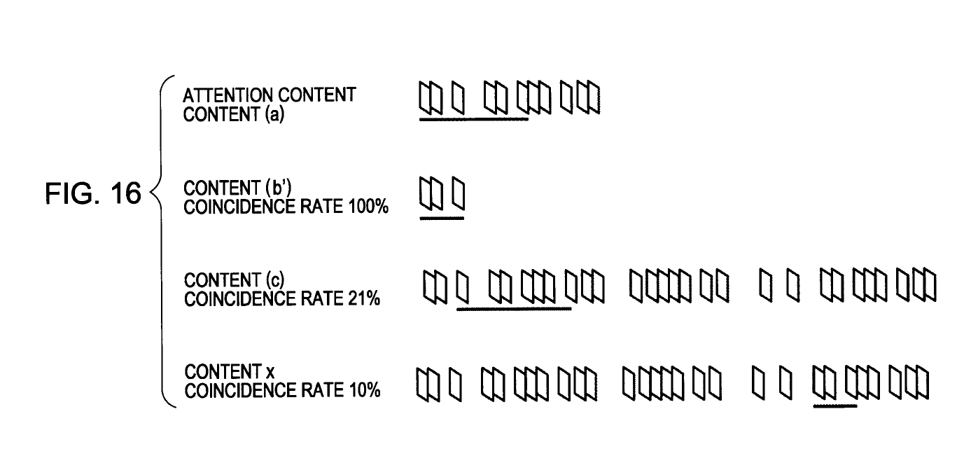

That is, the micro processor 31 computes data for displaying all frames located at predetermined intervals in addition to the frames to which the thumbnail image display flag is assigned as thumbnail images to be supplied to the GPU 32, and, for example, as illustrated in FIG. 16, the GUI screen where a large number of thumbnail images are displayed may be displayed on the display 18. At this time, the frame intervals for displaying the thumbnail images may be set narrow for the part set as the matching part or may be set narrow for the part set as the non-matching part. Also, in a case where the scene change is generated in the respective thumbnails, a thumbnail image corresponding to the first frame after the scene change may be displayed. The micro processor 31 can detect the scene change point of the respective contents through an arbitrary method used up to now.

It should be noted that in the metadata registered in the HDD 35, the thumbnail image display flag for the thumbnail image further added to be displayed in this manner is also registered in the metadata. That is, the micro processor 31 assigns the thumbnail image display flag to the frames at the predetermined intervals or the first frame after the scene change to update the metadata.

In addition, on the display screen in the time line mode, the user may specify a preferred point where the addition of display of the thumbnail image at a part where the thumbnail image is not displayed is desired and the thumbnail image corresponding to the time may be displayed.

At this time, the micro processor 31 assigns the thumbnail image display flag to the frame at the time corresponding to the content specified by the user on the basis of the operation input performed by the user which is supplied from the operation controller 15, the mouse 16, or the keyboard 17. Then, the micro processor 31 computes data for further displaying the thumbnail image corresponding to the frame to which the thumbnail image display flag is assigned and supplies the data to the GPU 32. The GPU 32 displays the GUI display screen where the thumbnail image is added and displayed at the position specified by the user on the display 18 on the basis of the information supplied from the micro processor 31.

In addition, in a case where the user instructs the cancellation of the display of the already displayed thumbnail images, on the basis of the operation input performed by the user which is supplied from the operation controller 15 or the mouse 16 via the south bridge 34, with respect to the metadata of the corresponding content, the micro processor 31 deletes the thumbnail image display flag of the frame corresponding to the frame image data corresponding to the coordinate specified by the user and also generates information for canceling the display of the thumbnail images to be supplied to the GPU 32. The GPU 32 cancels the display of the thumbnail images specified by the user on the basis of the information supplied from the micro processor 31.

It should be noted that the thumbnail image display flag for the thumbnail image further added and displayed from the case of the trajectory mode in this way may be the same as the thumbnail image display flag set in the trajectory mode or may be distinguishable from each other. In a case where the distinguishable flag is assigned, when the time line mode is once executed and the trajectory mode is executed on the content to which the thumbnail image display flag is added, in the trajectory mode, the thumbnail image added and display is not displayed. On the other hand, in a case where the same flag is assigned, when the time line mode is once executed and the trajectory mode is executed on the content to which the thumbnail image display flag is added, all the thumbnail images are displayed also in the trajectory mode.

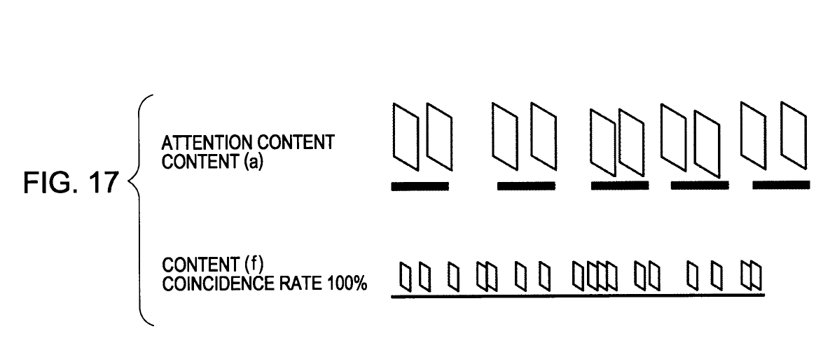

Also, for example, as described by using FIG. 14, even in a case where a part of the frames is intermittently deleted to shorten the content reproduction time or a case where a commercial break part is deleted, as illustrated in FIG. 17, with reference to the underline which indicates the matching part and the display of the thumbnail images at positions including the position desired by the user, it is possible for the user to easily suppose that, although the total reproduction times vary, the substances are matched with each other.

In addition, the attention content and the selection contents displayed in correspondence with the attention content can be changed of course. In order to change the attention content and the selection contents, for example, the mode is back to the trajectory mode again, and the content to be selected may be changed. Also, in order to change the attention content and the selection contents, contents which become new selection targets, that is, a clip list which is a list of contents whose metadata is registered in the HDD 35 is displayed in a different window, and a desired content may be selected from the clip list.

The micro processor 31 changes the selection content flag or the metadata to which the attention content flag is assigned on the basis of the operation input performed by the user which is supplied from the operation controller 15, the mouse 16, or the keyboard 17. Then, the micro processor 31 extracts the newly set selection content flag or metadata of the content to which the attention content flag is assigned. Then, the micro processor extracts, from the extracted metadata, the frames to which the starting point flag and the ending point flag are assigned, the frames to which the thumbnail image display flag is assigned, and the image data of the starting frame and the ending frame of the content. Then, similarly to the case which is described by using FIG. 15, on the same time line while the starting times of the attention content and the other contents are used as the reference, the thumbnail images in the starting frame and the ending frame of the respective contents, the thumbnail images in the starting point and the ending point of the parts supposed to be matched with each other, and the thumbnail images displayed in the trajectory mode are displayed, and the data for underlining the part recognized as the matching part is calculated to be supplied to the GPU 32. The GPU 32 displays the GUI display screen where the thumbnail image data of the newly selected attention content or selection content is displayed on the time line on the display 18 on the basis of the information supplied from the micro processor 31.

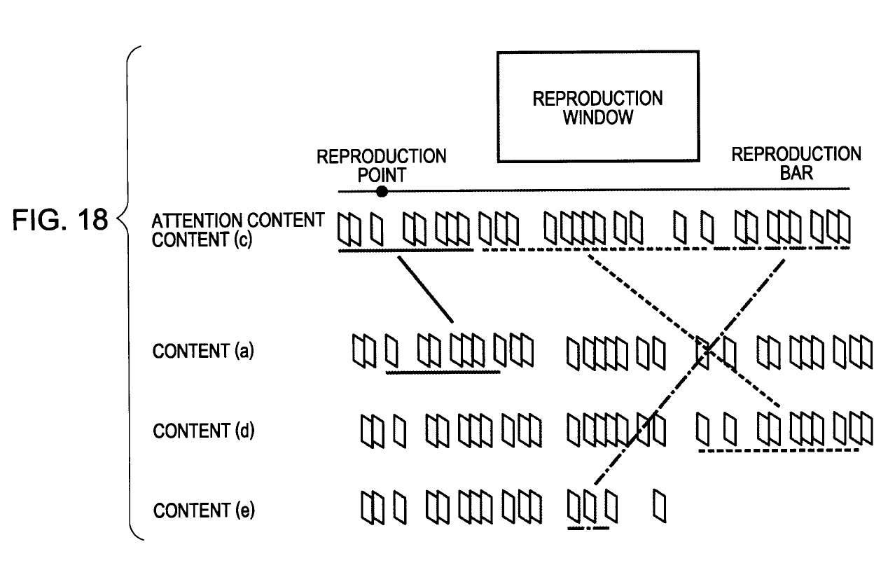

Also, in the time line mode, as illustrated in FIG. 18, the attention content may be reproduced and displayed on a separate window, and the reproduction position may be indicated on the time line.

In addition, in the case illustrated in FIG. 18, the attention content is set as the above-mentioned content (c), and the content (a), the content (d), and the content (e) are set as the selection contents. The edited content composed of a part of the respective selection contents is the attention content, and therefore the underline of the attention content is associated with the mutually different content (a) to content (c). In view of the above, in such a case, not only the same underline is displayed for all the parts recognized as being matched among the plurality of contents, but also the corresponding underlines are linked by a line to be displayed, a plurality of colors are used for the underlines to display the corresponding underlines in the same color, a plurality of underline types are used to set the same underline for the corresponding underlines, for example, so that it is possible to perform the display allowing the user to easily recognize which part of which content matches which part of which content the corresponding parts to find out the corresponding parts.

In a case where the display in the above-mentioned manner is performed, the micro processor 31 may assign the starting point flag and the ending point flag assigned to the corresponding metadata for each matching part with distinction.

In addition, in the image processing apparatus 11, the starting point and the ending point of the matching part set in the trajectory mode can be modified in the time line mode.

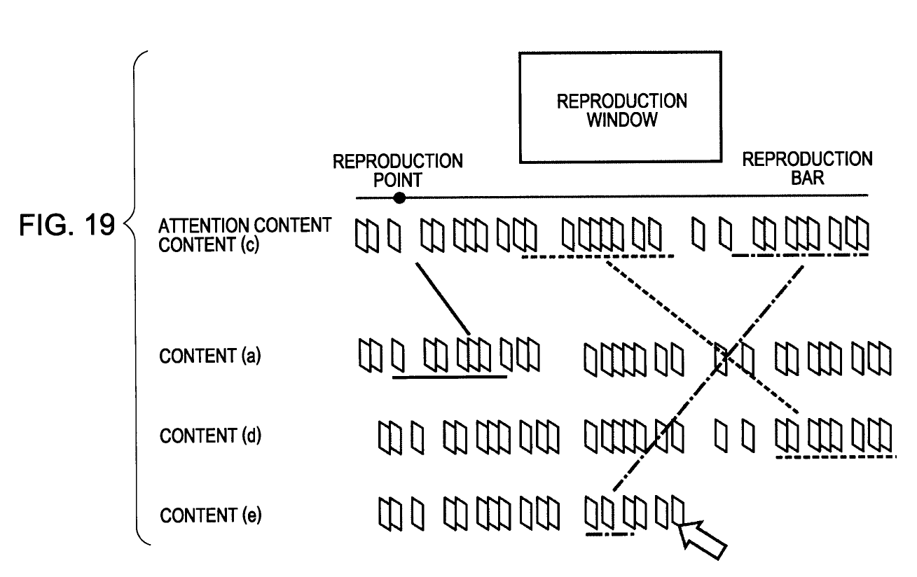

As described above, the user selects the desired point on the time line and can instruct the display of the thumbnail image corresponding to the time point. Then, the user checks the newly displayed thumbnail image, and as illustrated in FIG. 19, changes the length of the underline or performs the operation input of selecting a frame to be newly selected as a starting point or an ending point.

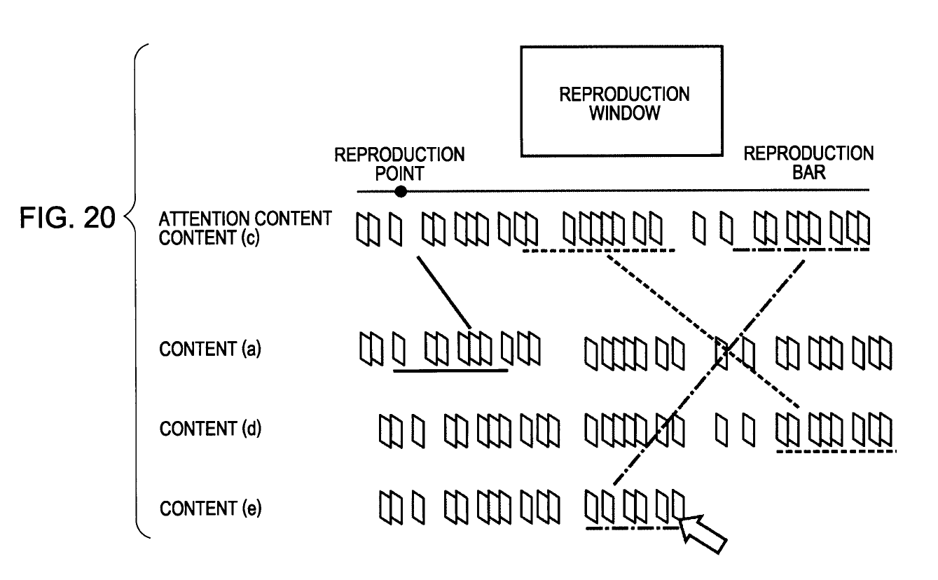

The micro processor 31 changes the positions of the starting point flag and the ending point flag of the corresponding metadata to update the metadata on the basis of the operation input performed by the user which is supplied from the operation controller 15, the mouse 16, or the keyboard 17. Then, on the basis of the updated metadata, the micro processor 31 extracts the frames to which the thumbnail image display flag is assigned, and the thumbnail images corresponding to those frames are displayed. Also, the micro processor 31 compute the data for underlining the corresponding part between those frames to be supplied to the GPU 32. On the basis of the information supplied from the micro processor 31, as illustrated in FIG. 20, the GPU 32 displays the GUI display screen where the length of the underline indicating the supposedly matching part is modified on the display 18 on the basis of the operation input performed by the user.

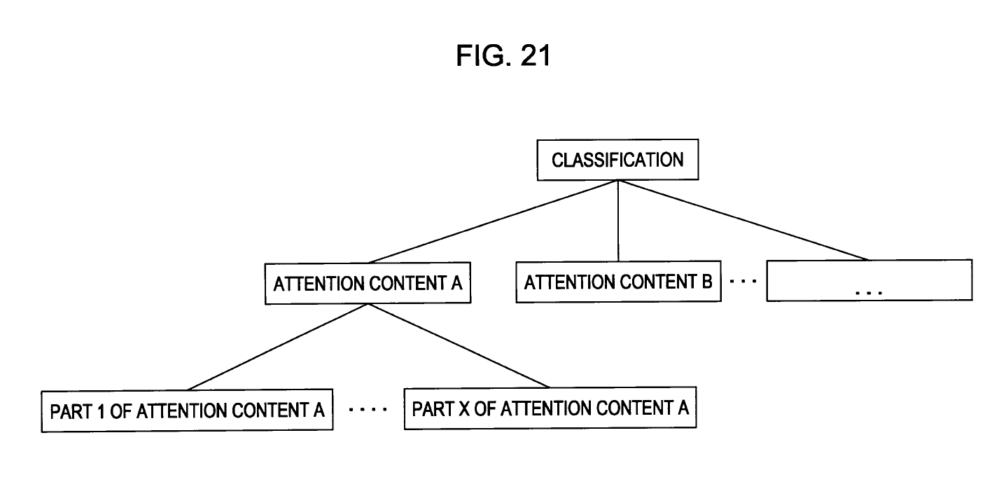

In this manner, in a case where parts of the content data accumulated by the user or the content data uploaded to the motion picture sharing site or the like are common to each other, if the relevance thereof can be sorted out, wasteful data is easily deleted or it is easy to search the edited content for the original content. While referring to the display in the time mode, for example, as illustrated in FIG. 21, the user can easily classify the partially common contents.

It should be noted that the description has been given of the case in which in the time line mode, basically, the selection contents and the attention content selected by the user in the trajectory mode are displayed on the set time axis, but irrespective of the selection of the contents in the trajectory mode, in the time line mode, the attention content and the selection contents may be set of course.

That is, in the image processing apparatus 11, for example, the selection target contents, that is, the clip list which is a list of contents whose metadata is registered in the HDD 35 is displayed in the different window, and from the list, the user can select the desired contents as the attention content and the selection contents in the time line mode.

On the basis of the operation input performed by the user which is supplied from the operation controller 15, the mouse 16, or the keyboard 17, the micro processor 31 assigns the selection content flag or the attention content flag to the corresponding metadata. Then, the micro processor 31 extracts the selection content flag or the metadata of the content to which the attention content flag is assigned. Then, the micro processor determines whether or not various flags exist in the extracted metadata. In a case where various flags exist in the extracted metadata, the frames to which the starting point flag and the ending point flag are assigned, the frames to which the thumbnail image display flag is assigned, and the image data of the starting frame and the ending frame of the content are extracted from the metadata. Similarly to the case described by using FIG. 15, on the same time line while the starting times of the attention content and the other contents are used as the reference, the thumbnail images in the starting frame and the ending frame of the respective contents, the thumbnail images in the frames to which the starting point flag and the ending point flag are assigned, and the thumbnail images which have been displayed in the trajectory mode are displayed, and data for underline the parts recognized as being matched is calculated and supplied to the GPU 32. The GPU 32 displays the GUI display screen where the thumbnail image data of the newly selected attention content or selection content on the time line is displayed on the display 18 on the basis of the information supplied from the micro processor 31.

It should be noted that in this case, when the extracted data does not contain the starting point flag and the ending point flag, the underline indicating the matching part is not displayed. Furthermore, in a case where the thumbnail image display flag does not exist in the extracted metadata, the thumbnail to be displayed may be the display of the thumbnail image corresponding to the frame at a predetermined period of time or the display of the frame corresponding to the scene change.

In this manner, in the image processing apparatus 11, without checking the images at the beginning of the plurality of respective contents or at scene changes, by checking the trajectory of the motion picture, it is possible to display the GUI display screen which becomes a support of selection as to whether or not there is a possibility that the parts are matched with each other.

To be more specific, in the trajectory mode, the setting of the three-dimensional coordinate axis is changed or the trajectory mode and the time line mode are repeated to display the thumbnail image at the desired position, for example, and even when the tendencies of parameters are matched with each other, it is possible to distinguish that the contents are different from each other in actuality. In addition, even in a case where the contents having the same substance have different parameters of the images due to the repeat of the image processing such as the editing, the change in the image size, and the compression and expansion, it is possible to find the matching parts.

With this configuration, for example, it is possible to reduce the burden for the copy right management in the motion picture sharing site. Also, in a case where the motion picture is uploaded to the motion picture sharing site by the user, it is possible to easily determine whether or not the motion picture having the same substance is already registered. Also, for an administrator who manages the motion picture sharing site too, it is possible to sort out or classify the contents when similar motion pictures are redundantly registered.

In addition, in a case where the user who views, for example, the edited content by referring to the display of the time line mode and putting a link on the motion picture which becomes the base of the respective scenes constituting the content after the edition is further interested in the relevant part, it is possible to easily provide a service enabling the viewing of the content which was used as the editing material by tracing the link.

In addition, in a case where a single user records a large number of contents too, even when the same contents are redundantly recorded or the contents are edited and the number of contents to be managed is extremely large including the material contents before the editing and the contents after the editing, by referring to the GUI display screen in the trajectory mode and the time line mode in the image processing apparatus 11, it is possible to check the matching parts of the contents and easily classify and sort out the contents.

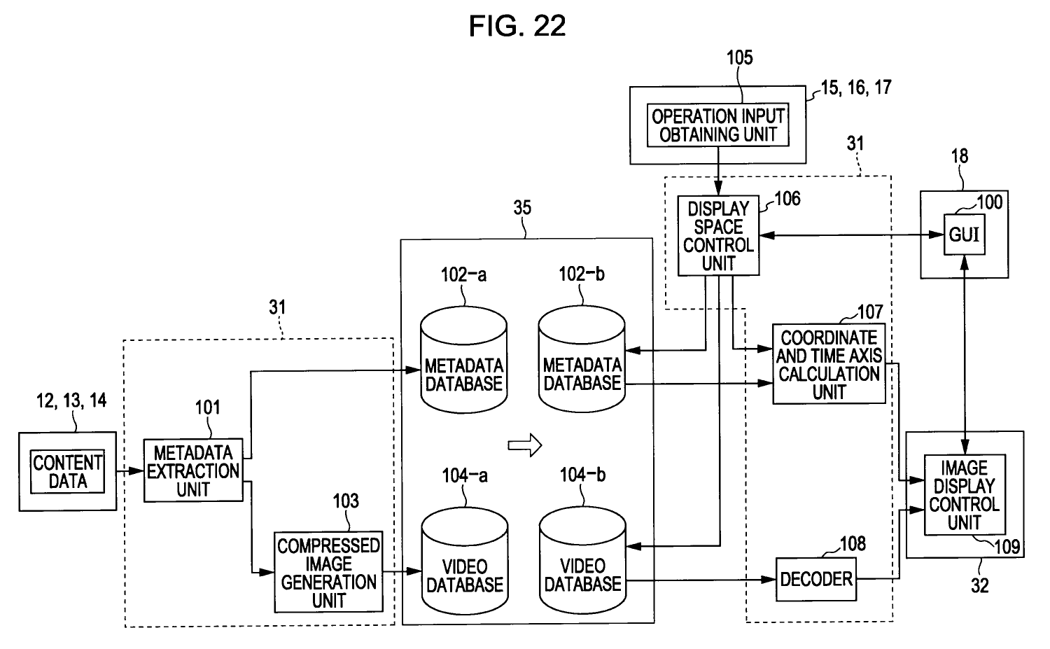

Next, FIG. 22 is a function block diagram for describing the functions of the image processing apparatus 11 for executing the processing in the above-mentioned trajectory mode and time line mode.

As illustrated in FIG. 22, content data is supplied from the storage apparatus 12, the video data input apparatuses 13-1 to 13-n, or the drive 14. Then, a metadata extraction unit 101, a compressed image generation unit 103, a display space control unit 106, a coordinate and time axis calculation unit 107, and a decoder 108 are allowed to function by the micro processor 31.

In addition, a metadata database 102 and a video database 104 are predetermined areas of the HDD 35. Then, an operation input obtaining unit 105 adapted to obtain an operation input performed by the user copes with the operation controller 15, the mouse 16, and the keyboard 17, and an image display control unit 109 adapted to perform a display control on a GUI 100 displayed on the display 18, rendering, and the like copes with the GPU 32.

Herein, a description will be given of such a configuration that the characteristic parameter is previously extracted from the individual pictures constituting the video data as metadata, and the metadata is used to display the video data, but while the metadata is generated from the individual pictures constituting the video data, the above-mentioned GUI display screen may be displayed. Also, in a case where the metadata is previously assigned to the content data to be obtained, by using the metadata, the above-mentioned GUI display screen may be displayed.

In addition, the image processing apparatus 11 may only performs a processing of extracting, for example, the characteristic parameter of the thus obtained content data to be registered in the metadata database 102, and when necessary, compressing the content data to be registered in the video database 104, or only performs a processing of using the metadata generated by another apparatus to display the above-mentioned GUI display screen for the thus obtained content data. That is, functions described on the left of a metadata database 102-a and a video database 104-a in the drawing and functions described on the right of a metadata database 102-b and a video database 104-b may be realized by different apparatuses, respectively. In a case where the image processing apparatus 11 executes both the metadata extraction and the display processing, the metadata database 102-a and the metadata database 102-b are composed of the same database, and the video database 104-a and the video database 104-b are composed of the same database.

The metadata extraction unit 101 extracts the characteristic parameters indicating the various characteristic amounts from the AV data constituting the content data and registers these characteristic parameters in the metadata database (metadata DB) 102 as the metadata with respect to the content data.

The compressed image generation unit 103 compresses the respective pictures of the video data supplied via the metadata extraction unit 101 to be registered in the video database (video DB) 104. Also, the compressed image generation unit 103 may further thin out the number of pixels of the respective pictures in the video data at a predetermined rate and register the video stream with a fewer pixels obtained as the result of the thinning out in the video DB 104. In a case where the video stream with a fewer pixels is previously generated, the above-mentioned thumbnail images can be easily generated, which is preferable.

The operation input obtaining unit 105 obtains the operation input performed by the user who refers to the GUI 100 in which the display on the display 18 is controlled through the processing of the image display control unit 109 which has been described by using FIGS. 3 to 20 and supplies the operation input to the display space control unit 106.

The display space control unit 106 obtains the operation input performed by the user who refers to the GUI 100 displayed on the display 18 from the operation input obtaining unit 105, recognizes the parameters at the display axis used for the generation of the three-dimensional display space specified by the user, and reads out the necessary metadata from the metadata database 102 to be supplied to the coordinate and time axis calculation unit 107. Also, the display space control unit 106 recognizes the content corresponding to the three-dimensional display space in the trajectory mode, the content corresponding to the thumbnail images displayed in the time line mode, and the like, and supplies the information related to the content selected by the user or the information related to a predetermined time point of the content to the coordinate and time axis calculation unit 107. Then, the display space control unit 106 reads out the metadata of the predetermined content from the metadata database 102 to be supplied to the coordinate and time axis calculation unit 107, and reads out the data of the predetermined content from the video database 104 to be supplied to the decoder 108.

In the trajectory mode, the coordinate and time axis calculation unit 107 refers to the metadata of the displayed respective contents to set the characteristic parameters supplied from the display space control unit 106 at the display axis in the display space, converts the characteristic parameters into coordinates in the three-dimensional display space (coordinate parameters) through a calculation, and decides the trajectory in the three-dimensional display space or the arrangement positions of the thumbnail images in accordance with the converted coordinate parameters. Then, the coordinate and time axis calculation unit 107 supplies the information necessary to display a plurality of trajectories to be arranged in the three-dimensional display space or thumbnail images at the decided arrangement positions to the image display control unit 109.

In addition, in the time line mode, on the basis of the reproduction time of the display content or the like, the coordinate and time axis calculation unit 107 sets the time axis on the screen and refers to the metadata of the displayed respective contents to supply the information necessary to display the thumbnail images at the decided arrangement positions to the image display control unit 109.

The decoder 108 decodes the video stream supplied from the video DB 104 and sends the decoded video data obtained as the result of the decoding to the image display control unit 109.

The image display control unit 109 uses the various information supplied from the coordinate and time axis calculation unit 107 and the video data supplied from the decoder 108 to control the display on the display 18 of the GUI 100 which has been described by using FIGS. 3 to 20.

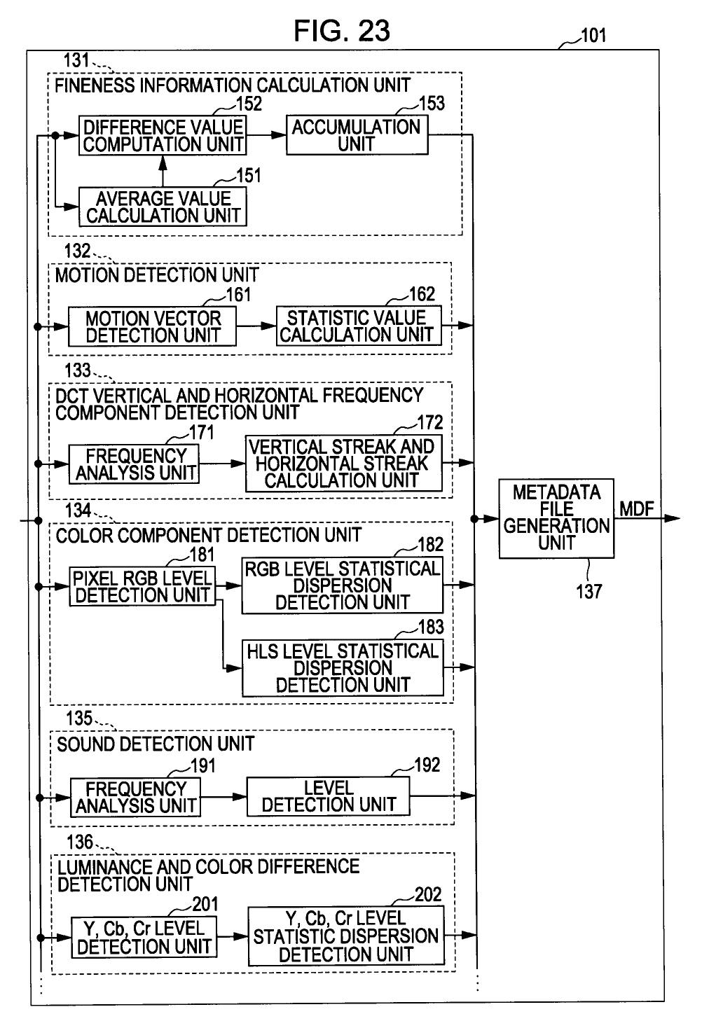

Next, FIG. 23 is a function block diagram for describing the further detailed function example in the metadata extraction unit. In FIG. 23, as examples of the metadata to be extracted, the image fineness, motion, DCT vertical and horizontal frequency components, color component, audio, and luminance will be described, but, as described above, the metadata that can be extracted is not limited to the above.

The metadata extraction unit 101 is composed of a fineness information calculation unit 131, characteristic amount detection means such as a motion detection unit 132, a DCT vertical and horizontal frequency component detection unit 133, a color component detection unit 134, a sound detection unit 135, and a luminance and color difference detection unit 136, and a metadata file generation unit 137. It should be noted that the metadata extraction unit 101 may be provided with various detection units adapted to extract characteristic amounts of parameters other than the above-mentioned parameters.

The fineness information calculation unit 131 is composed of an average value calculation unit 151, a difference value computation unit 152, and an accumulation unit 153.

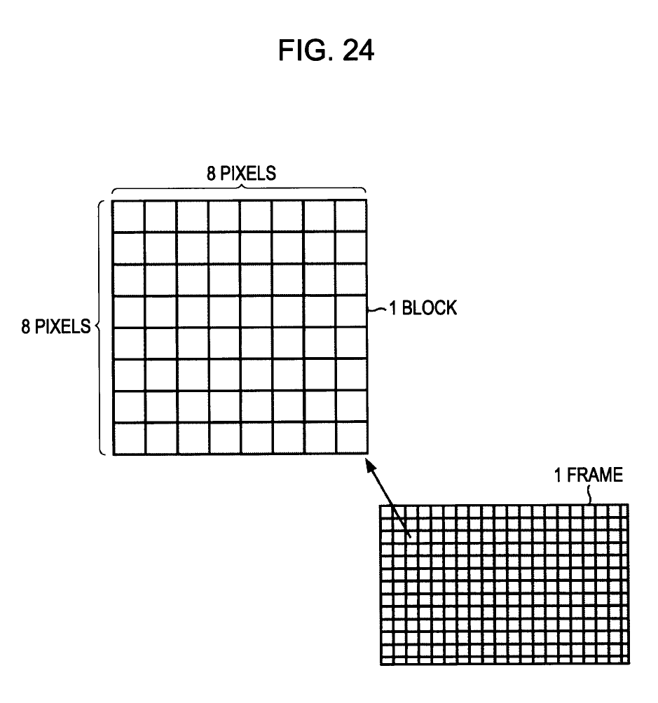

The average value calculation unit 151 receives the supply of the video data, sequentially set the frames of the video data as the attention frame, and divides the attention frame, for example, as illustrated in FIG. 24, into a block of 8×8 pixels. Furthermore, the average value calculation unit 151 calculates an average value of the respective blocks in the attention frame and supplies this average value to the difference value computation unit 152.

Herein, in a case where the pixel value of the k-th pixel in the raster scan order of 8×8 pixel block is represented by Pk, the average value calculation unit 151 calculates an average value Pave of the pixel values by using the following expression (1).

Pave=1/(8×8)×ΣPk (1)

It should be noted that the summation E in the expression (1) represents the summation which is obtained while k is changed from 1 up to 8×8 (=64).

Similarly to the average value calculation unit 151, the difference value computation unit 152 divides the attention frame into the block of 8×8 pixels and finds out an absolute value |Pk−Pave| of the difference value between the respective pixel values Pk for the block and the average value Pave of the pixel values for the block which is supplied from the average value calculation unit 151. Then, the difference value computation unit 152 supplies the absolute value to the accumulation unit 153.

The accumulation unit 153 accumulates the absolute values |Pk−Pave| of the difference values which are obtained for the respective pixels for the block supplied from the difference value computation unit 152 to find out an accumulation value Q=Σ|Pk−Pave|. Herein, the summation Σ in the accumulation value Q=Σ|Pk−Pave| represents the summation which is obtained while k is changed from 1 up to 8×8 (=64).

Furthermore, the accumulation unit 153 finds out a total sum of the accumulation values Q which are obtained for all the blocks in the attention frame and outputs this to the metadata file generation unit 137 as fineness information QS1 in the attention frame.

It should be noted that the total sum of the accumulation values Q obtained for the attention frame is called an Intra-AC. As the value of Intra-AC is larger, the pixel values in the attention frame fluctuate more largely. Therefore, as the fineness information QS1 which is the total sum of the accumulation values Q is larger, it means that the attention frame is a fine (complex) image.

The motion detection unit 132 is composed of a motion vector detection unit 161 and a statistic value calculation unit 162.

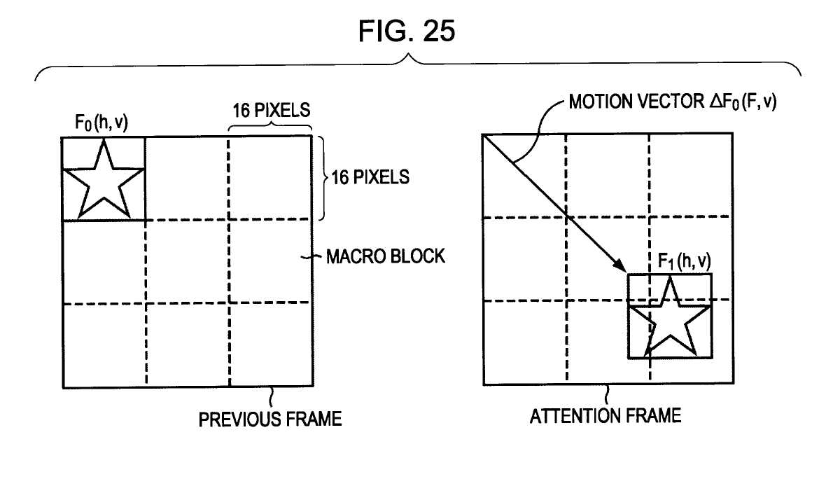

The motion vector detection unit 161 divides the previous frame into the macro block of 16×16 pixels as illustrated in FIG. 25 and detects the block of the 16×16 pixels in the attention frame which is most similar to the macro block (hereinafter, which is referred to as similar block) for the respective macro frames in the previous frame. Then, the motion vector detection unit 161 finds the vector in which, for example, the upper left of the macro block is set as the starting point and the upper left of the similar block is set as the ending point as the motion vector ΔF₀ (h, v) in the macro block.

Now, when the position of the macro block which is h-th on the left and v-th from the top from the previous frame is represented by F₀ (h, v) and also the block of 16×16 pixels of the attention frame at the position shifted by the motion vector ΔF0 (h, v) in the macro block F₀ (h, v) from the block of the macro block F₀ (h, v), that is, the position of the similar block is represented by F₁ (h, v), a motion vector ΔF₀ (h, v) of the macro block F₀ (h, v) is represented by the following expression (2).

ΔF₀(h, v)=F₁(h, v)−F₀(h, v) (2)

The statistic value calculation unit 162 finds a total sum D0=Σ|ΔF₀ (h, v)| of the size |ΔF₀ (h, v)| in the motion vector ΔF₀ (h, v) of all the macro blocks in the previous frame as a statistic value of the motion vector calculated for the macro block in the previous frame, for example, and outputs the total sum D0 as the motion information in the attention frame.

It should be noted that the summation Σ in the total sum D₀=Σ|ΔF₀ (h, v) represents the summation in which h is changed from 1 up to the number of the macro block in the horizontal direction of the previous frame and also v is changed from 1 up to the number of the macro block in the vertical direction of the previous frame.

Herein, when the size of the motion vector ΔF₀ (h, v) in the respective macro blocks F₀ (h, v) in the previous frame is large, the motion information Do which is the sum thereof is also large. Therefore, in a case where the motion information D₀ in the attention frame is large, the motion of the image in the attention frame is also large (rough).

It should be noted that in the above-mentioned case, the total sum D₀=Σ|ΔF₀ (h, v)| of the sizes |ΔF₀ (h, v)| in the motion vectors ΔF₀ (h, v) in all the macro blocks in the previous frame is obtained as the statistic value of the motion vector calculated for the macro block in the previous frame, but as the statistic value of the motion vector calculated for the macro block in the previous frame, in addition to the above, for example, it is possible to adopt the dispersion of the motion vectors calculated for the macro block in the previous frame.

In this case, the statistic value calculation unit 162 obtains an average value Δave of the motion vectors ΔF₀ (h, v) in all the macro blocks in the previous frame, and the dispersion σ₀ of the motion vectors ΔF₀ (h, v) in all the macro blocks F₀ (h, v) in the previous frame is obtained, for example, through the computation of the following expression (3).

σ₀=Σ(ΔF₀(h, v)−Δave)² (3)

It should be noted that the summation Σ in the dispersion in the expression (3) represents the summation in which h is changed from 1 up to the number of the macro blocks in the horizontal direction in the previous frame and also v is changed from 1 up to the number of the macro blocks in the vertical direction in the previous frame.

The dispersion σ₀ is also large when the motion of the attention frame is large (rough) similarly to the total sum D₀.

It should be noted that the motion detection unit 132 creates a simplified histogram of the pixel values in the respective frames, and the differential absolute value sum between the histogram of a certain frame and the histogram with respect to the previous frame may be set as the motion information in the attention frame.

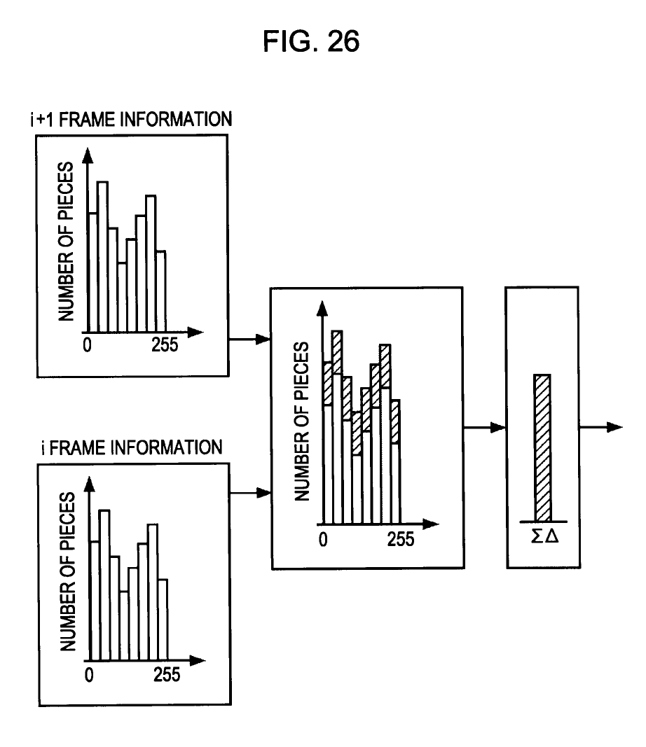

For example, when the number of pixels of the video data is represented in 8 bits, for example, which is representative by an integer from 0 to 255, as illustrated in FIG. 26, the motion detection unit 132 creates simplified histograms of the pixel values in an i-th frame and (i+1)-th frame at a width of a predetermined pixel value, obtains a total sum (differential absolute value sum) ΣΔ of absolute values Δ of difference values of mutual frequencies (a part which is shaded in FIG. 26) in the same small range of these histograms, and outputs the total sum as the motion information of the attention frame to the metadata file generation unit 137.

Herein, in a case where the motion of the attention frame is large (rough), the frequency distribution of the pixel values in the attention frame is different from the frequency distribution of the pixel values in the previous frame. Therefore, in a case where the differential absolute value sum ΣΔ in the attention frame is large, the motion of the attention frame is large (rough).

Next, the DCT vertical and horizontal frequency component detection unit 133 is composed by including a frequency analysis unit 171 and a vertical streak and horizontal streak calculation unit 172.

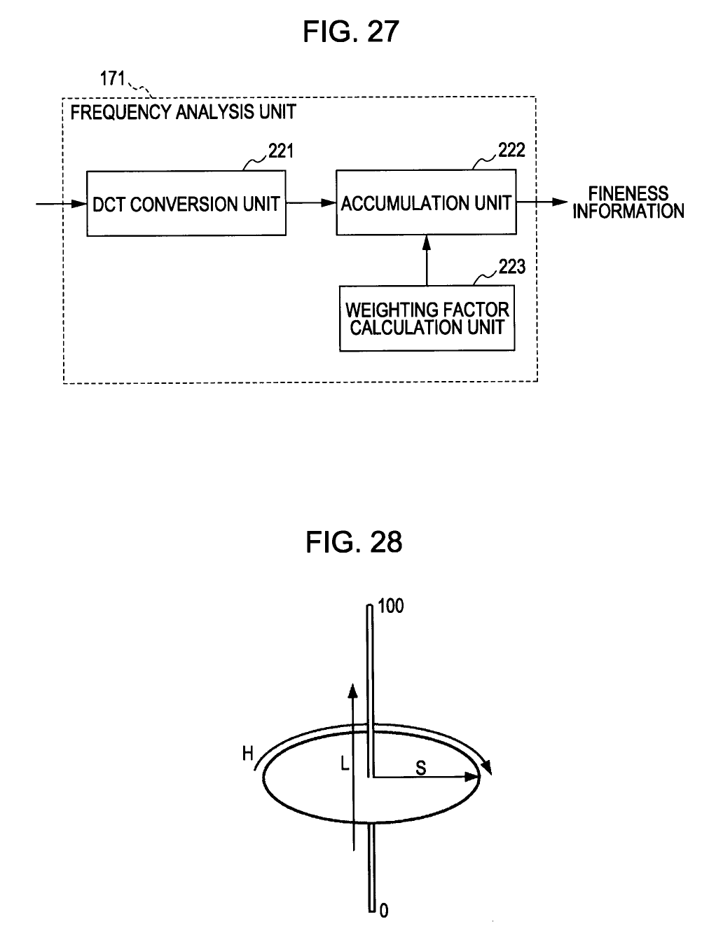

FIG. 27 is a function block diagram of a configuration example of the frequency analysis unit 171 in the DCT vertical and horizontal frequency component detection unit 133. The frequency analysis unit 171 is composed of a DCT conversion unit 221, an accumulation unit 222, and a weighting factor calculation unit 222.

The DCT conversion unit 221 is supplied with the video data, and the frame of this video data is sequentially set as the attention frame. Then, the attention frame is divided, for example, into the block of 8×8 pixels. Furthermore, the DCT conversion unit 221 performs the DCT conversions on the respective blocks in the attention frame, and the 8×8 DCT coefficients obtained in the respective blocks are supplied to the accumulation unit 222.

The weighting factor calculation unit 222 obtains the weighting applied to the 8×8 respective DCT coefficients of the block to be supplied to the accumulation unit 222. The accumulation unit 222 applies the weighting supplied from the weighting factor calculation unit 222 to the 8×8 respective DCT coefficients supplied from the DCT conversion unit 221 for the accumulation to obtain the accumulation value. Furthermore, the accumulation unit 222 obtains the total sum of the accumulation values obtained for the respective blocks in the attention frame and sends this total sum as the fineness information in the attention frame to the vertical streak and horizontal streak calculation unit 172.

Herein, as more high frequency components are included in the attention frame, the fineness information which is the total sum K of the accumulation values V is larger, it means that the image in the attention frame is a fine (complex) still image.

Then, the vertical streak and horizontal streak calculation unit 172 in the DCT vertical and horizontal frequency component detection unit 133 is adapted to detect on the basis of the DCT coefficient in an area AR₁ in the attention frame that the image contains a fine vertical streak, that is, the image has a high frequency in the horizontal direction, and detect on the basis of the DCT coefficient in an area AR₂ in the attention frame that the image contains a fine horizontal streak, that is, the image has a high frequency in the vertical direction.

With this configuration, in the DCT vertical and horizontal frequency component detection unit 133, the frequency analysis unit 171 can determine whether or not the image in the attention frame is a fine (complex) still image and also can determine at which levels the frequency in the horizontal direction and the frequency in the vertical direction are. The information is output as DCT vertical and horizontal frequency component information FVH to the metadata file generation unit 137.

Then, the color component detection unit 134 is composed of a pixel RGB level detection unit 181, a RGB level statistical dispersion detection unit 182, and an HLS level statistical dispersion detection unit 183.

The pixel RGB level detection unit 181 detects the RGB levels of the respective pixels in the attention frame of the video data, and sends the detection result to the RGB level statistical dispersion detection unit 182 and the HLS level statistical dispersion detection unit 183.

The RGB level statistical dispersion detection unit 182 calculates a statistic and a dispersion with respect to the RGB levels of the respective pixels in the attention frame supplied from the pixel RGB level detection unit 181, and outputs statistical values indicating at which levels the respective color components of RGB in the attention frame are and dispersion values indicating that color components in the attention frame are applied as a whole color or a local color as color component information CL₁ to the metadata file generation unit 137.

The HLS level statistical dispersion detection unit 183 converts the RGB levels of the respective pixels in the attention frame supplied from the pixel RGB level detection unit 181 into three components of Hue, Saturation, and Luminance/Lightness to be calculated as the statistic and the dispersion of the respective elements in the HLS space composed of these hue, saturation, and the luminance illustrated in FIG. 28. The HLS level statistical dispersion detection unit 183 outputs the detection result as HLS information CL₂ to the metadata file generation unit 137.

Herein, the hue in the HLS space represents a color by an angle in a range between 0 degree and 359 degrees. 0 degree represents red and 180 degrees located on the opposite side represents blue green which is the opposite of red. That is, it is easily to find the opposite color in the HLS space.

The saturation in the HLS space is a rate where chromatic colors are mixed. In particular, the HLS space is based on such a concept that as different from an HLS (Hue, Saturation, and Value) space, when the saturation is decreased from the saturated color, that is, the color becomes gray. When the color is close to gray, the saturation is low, and the color is away from gray, the saturation is high.

The luminance in the HLS space means that the luminance 0% is set as black and the luminance 100% is set as white, and the middle is set as pure white as different from the HLS space in which the luminance 100% is set as the saturated color and the luminance is decreased from the saturated color.

Therefore, the HLS level statistical dispersion detection unit 183 can output the HLS information CL₂ in which the hue is represented in an easily recognizable manner as compared with the RGB space to the metadata file generation unit 137.

The sound detection unit 135 is composed of a frequency analysis unit 191 and a level detection unit 192.

The frequency analysis unit 191 receives the supply of the audio data corresponding to the attention frame of the video data to analyze the frequency, and notifies the level detection unit 192 of the frequency band.

The level detection unit 192 detects the level of the audio data in the frequency band notified from the frequency analysis unit 191 and outputs audio level information AL to the metadata file generation unit 137.

The luminance and color difference detection unit 136 is composed of a Y, Cb, Cr level detection unit 201 and a Y, Cb, Cr level statistic dispersion detection unit 202.

The Y, Cb, Cr level detection unit 201 receives the supply of the video data, detects the luminance level of the luminance signal Y of the respective pixels in the attention frame of the video data and the signal levels of the color difference signals Cb and Cr, and supplies these to the Y, Cb, Cr level statistic dispersion detection unit 202.

The Y, Cb, Cr level statistic dispersion detection unit 202 calculates the statistic and the dispersion with respect to the luminance level of the luminance signal Y of the respective pixels and the signal levels of the color difference signals Cb and Cr in the attention frame supplied from the Y, Cb, Cr level detection unit 201 and outputs the statistic values indicating at which levels the luminance signal Y in the attention frame and the color difference signals Cb and Cr are and the luminance signal Y in the attention frame and the dispersion values the color difference signals Cb and Cr as color component information CL₃ to the metadata file generation unit 137.

Then, on the basis of the fineness information QS₁ obtained from the fineness information calculation unit 131, the motion information D₀ in the attention frame obtained from the motion detection unit 132, the DCT vertical and horizontal frequency component information FVH obtained from the DCT vertical and horizontal frequency component detection unit 133, the color component information CL₁ and the HLS information CL₂ obtained from the color component detection unit 134, the audio level information AL obtained from the sound detection unit 135, and the color component information CL₃ obtained from the luminance and color difference detection unit 136, the metadata file generation unit 137 generates the characteristic parameters of the picture constituting the video data or the characteristic parameters of the audio data corresponding to the video data as the metadata file including the metadata and outputs this metadata file.

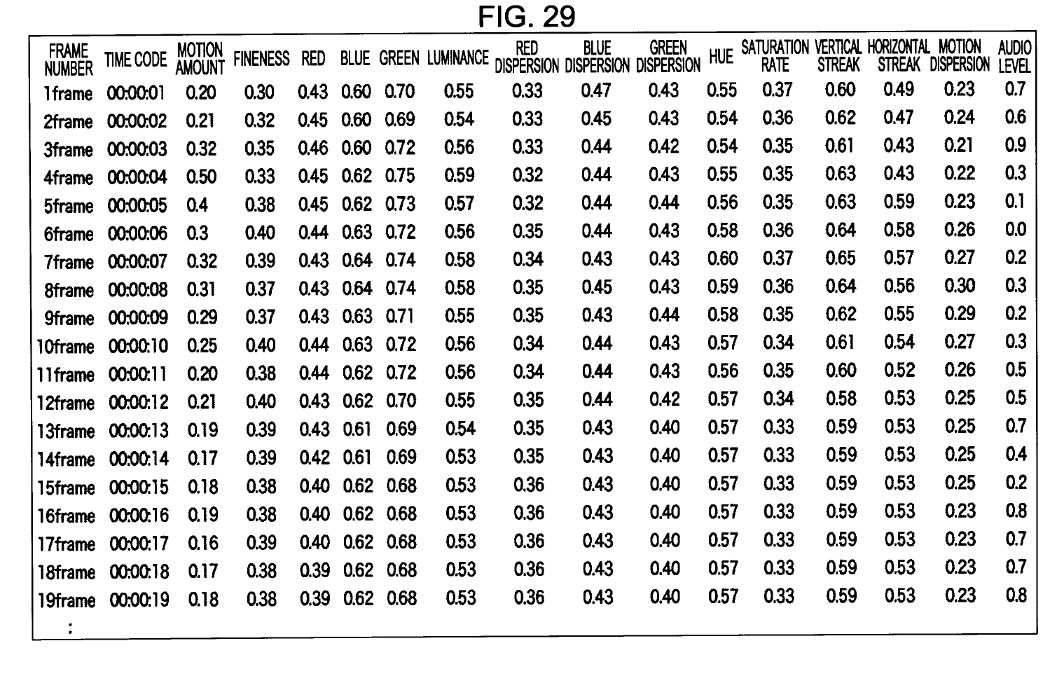

In this metadata file, for example, as illustrated in FIG. 29, for every a plurality of pictures from the first frame to the last frame constituting the content data, various characteristic parameters including “time code”, “motion amount”, “fineness”, “red”, “blue”, “green”, “luminance”, “red dispersion”, “green dispersion”, “hue”, “saturation degree”, “vertical streak”, “horizontal streak”, “motion dispersion”, “audio level”, and the like are registered.

It should be noted that as the value of the respective characteristic amounts of the metadata illustrated in FIG. 29, a relative value normalized between 0 and 1 is used. However, the value of the parameter is not limited to this, and, for example, an absolute value may be used. Also, a substance of the metadata file is also not limited to the characteristic amount of the above-mentioned characteristic parameter. For example, in the above-mentioned trajectory mode, in a case where the trajectory in the space where one of the characteristic amounts is used as the axis is displayed on the basis of the corresponding content, it is preferable to also register the coordinate value on the three-dimensional space as one type of the metadata.

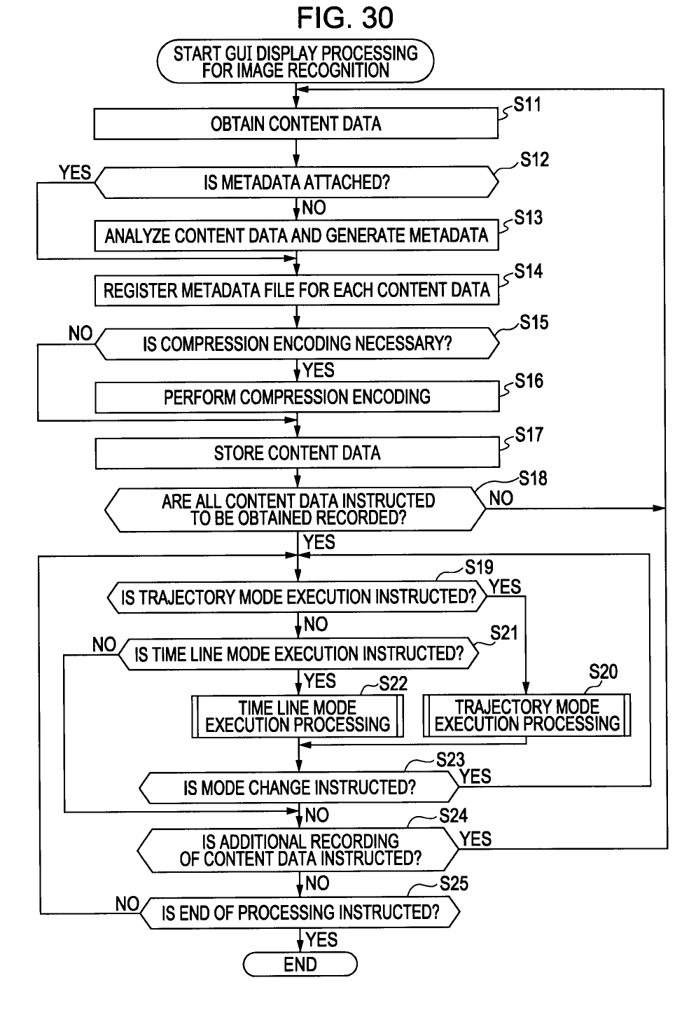

Next, with reference to a flowchart of FIG. 30, a GUI display processing for image recognition executed by the image processing apparatus 11 will be described.

In step S11, the metadata extraction unit 101 obtains the content data.

In step S12, the metadata extraction unit 101 determines whether or not metadata is attached to the thus obtained content data.

In step S12, in a case where it is determined that the metadata is not attached, in step S13, the metadata extraction unit 101 analyzes the content data in the manner described while using FIGS. 23 to 28 to generate the metadata, for example, illustrated in FIG. 29.

In step S12, in a case where it is determined that the metadata is attached, or after the processing in step S13, in step S14, the metadata extraction unit 101 supplies a metadata file which is composed of the attached or generated metadata to the metadata database 102. The metadata database 102 registers the supplied metadata file so as to be distinguishable for each content data and also supplies the content data to the compressed image generation unit 103.

In step S15, the compressed image generation unit 103 determines whether or not the compression encoding is necessary to register the supplied content data in the video database 104.

In step S15, in a case where it is determined that the compression encoding is necessary, in step S16, the compressed image generation unit 103 performs the compression encoding on the supplied content data.

In step S15, in a case where it is determined that the compression encoding is not necessary or after the processing in step S16, in step S17, the compressed image generation unit 103 supplies the content data to the video database 104. The video database 104 stores the supplied content data.

In step S18, the compressed image generation unit 103 determines whether or not all pieces of the content data instructed to be obtained are recorded. In step S18, in a case where it is determined that the recording of the content data instructed to be obtained is not yet ended, the processing is returned to step S11, and this and subsequent processing will be repeated.

In step S18, in a case where it is determined that all pieces of the content data instructed to be obtained are recorded, in step S19, on the basis of the operation input performed by the user which is supplied from the operation input obtaining unit 105, the display space control unit 106 determines whether or not the execution of the trajectory mode is instructed.

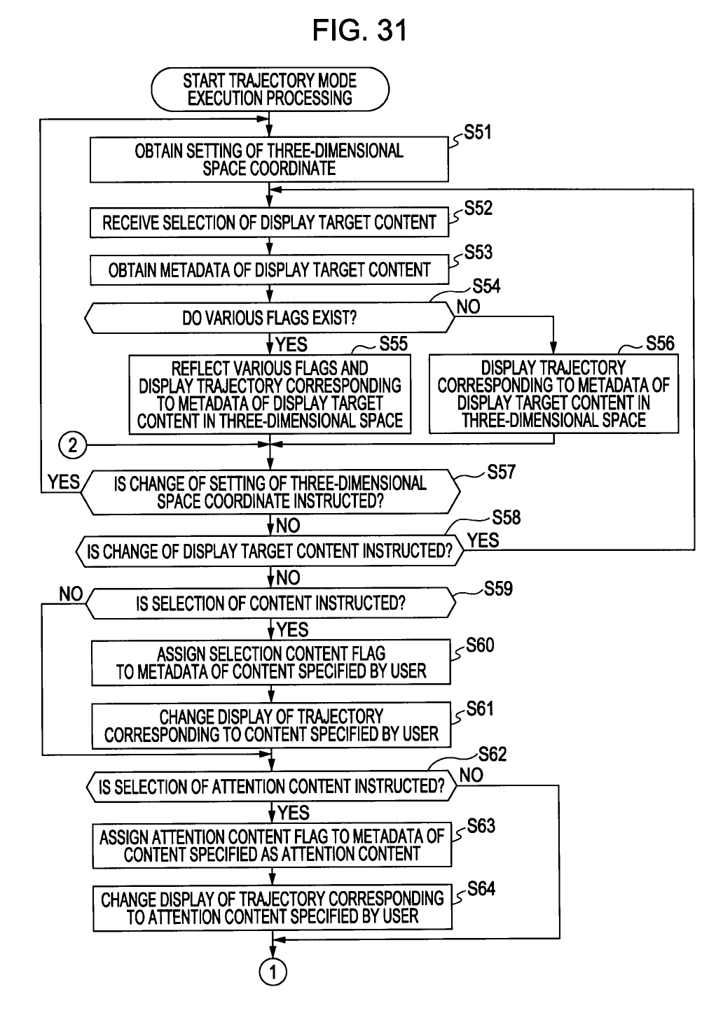

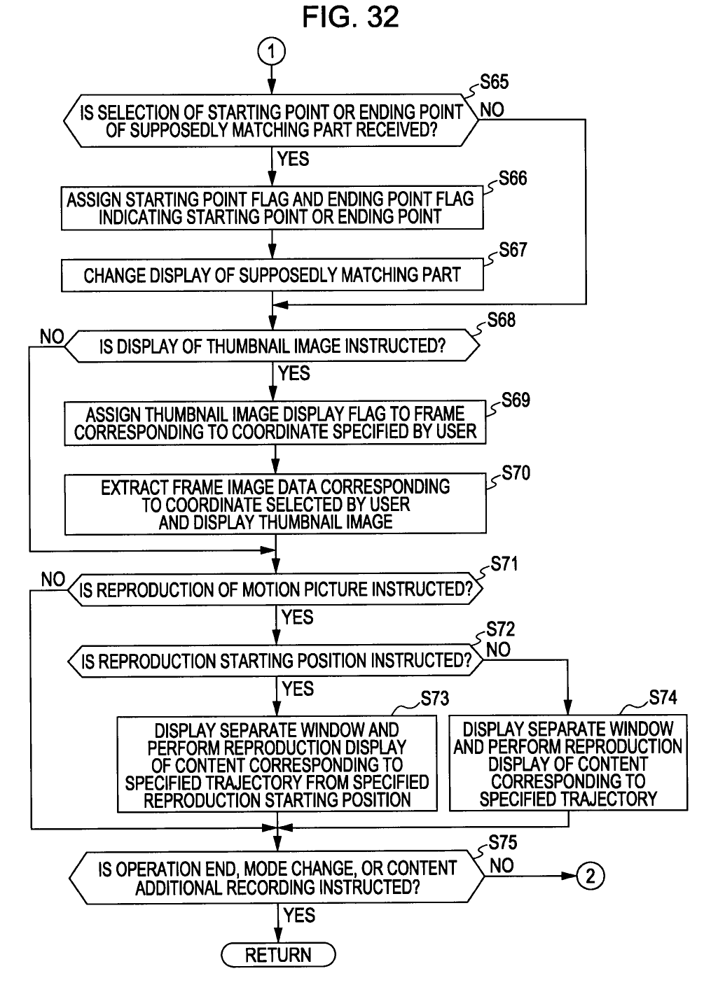

In step S19, in a case where it is determined that the execution of the trajectory mode is instructed, in step S20, a trajectory mode execution processing is executed which will be described below while using FIGS. 31 and 32.

In step S19, in a case where it is determined that the execution of the trajectory mode is not instructed, in step S21, on the basis of the operation input performed by the user which is supplied from the operation input obtaining unit 105, the display space control unit 106 determines whether or not the execution of the time line mode is instructed.

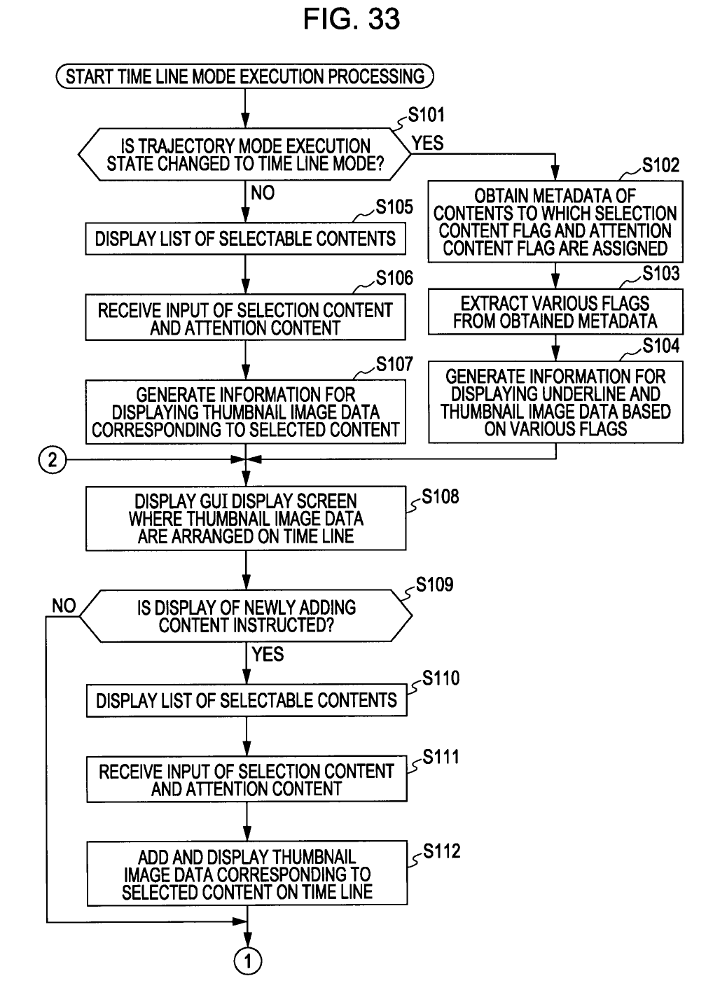

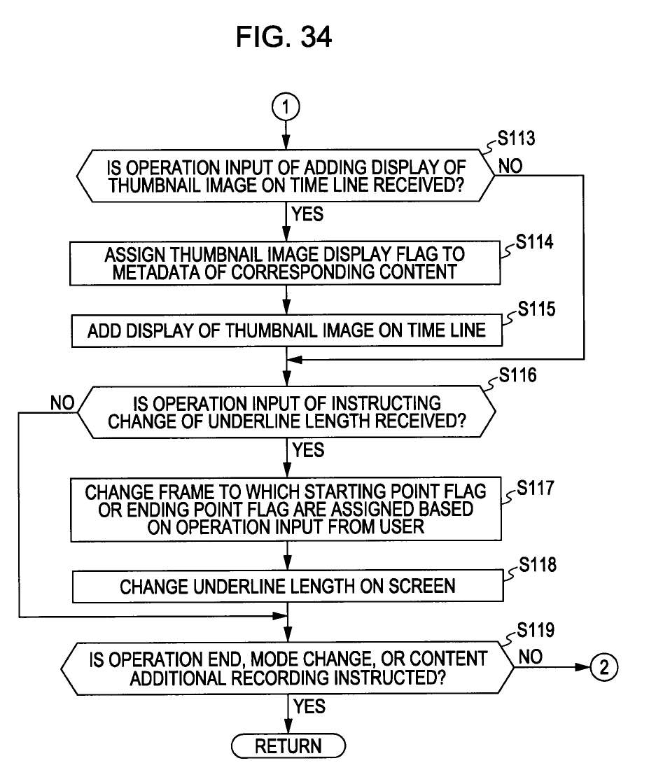

In step S21, in a case where it is determined that the execution of the time line mode is instructed, in step S20, a time line mode execution processing is executed which will be described below while using FIGS. 33 and 34.

After the processing in step S20 or S22, in step S23, on the basis of the operation input performed by the user which is supplied from the operation input obtaining unit 105, the display space control unit 106 determines whether or not the mode change is instructed. In step S23, in a case where it is determined that the mode change is instructed, the processing is returned to step S19, and this and subsequent processing will be repeated.

In step S23, in a case where it is determined that the mode change is not instructed, in step S24, on the basis of the operation input performed by the user which is supplied from the operation input obtaining unit 105, the display space control unit 106 determines whether or not the additional recording of the content data is instructed. In step S24, in a case where it is determined that the additional recording of the content data is instructed, the processing is returned to step S11, and this and subsequent processing will be repeated.

In step S24, in a case where it is determined that the additional recording of the content data is not instructed, in step S25, on the basis of the operation input performed by the user which is supplied from the operation input obtaining unit 105, the display space control unit 106 determines whether or not the end of the processing is instructed. In step S25, in a case where it is determined that the end of the processing is not instructed, the processing is returned to step S19, and this and subsequent processing will be repeated.

In step S25, in a case where it is determined that the end of the processing is instructed, the processing is ended.

Through such a processing, the metadata of the thus obtained contents is registered, and on the basis of the operation input performed by the user, the trajectory mode or the time line mode is executed.

Next, with reference to flowcharts of FIGS. 31 and 32, the trajectory mode execution processing in step S20 of FIG. 30 will be described.

In step S51, on the basis of the initial setting or the operation input performed by the user which is supplied from the operation input obtaining unit 105, the display space control unit 106 obtains the setting of the coordinate in the three-dimensional space, and recognizes the parameter of the display axis used for the generation of the three-dimensional display space specified by the user.

In step S52, the operation input obtaining unit 105 receives the selection of the display target content to be supplied to the display space control unit 106. On the basis of the operation input performed by the user which is supplied from the operation input obtaining unit 105, the display space control unit 106 reads the necessary metadata from the metadata database 102 and supplies the metadata to the coordinate and time axis calculation unit 107.

In step S53, the coordinate and time axis calculation unit 107 obtains the metadata of the display target content.

In step S54, the coordinate and time axis calculation unit 107 determines whether or not various flags exist in the thus obtained metadata.

In step S54, in a case where it is determined that various flags exist in the thus obtained metadata, in step S55, the coordinate and time axis calculation unit 107 reflects the various flags, refers to the metadata of the displayed respective contents, and sets the characteristic parameters supplied from the display space control unit 106 at the display axis in the display space. The coordinate and time axis calculation unit 107 converts the characteristic parameters into the coordinates in the three-dimensional display space (coordinate parameters) through a calculation, and in accordance with values of the converted coordinate parameters, the trajectory in the three-dimensional display space, the line type thereof, and the arrangement positions for the thumbnail images. Then, the coordinate and time axis calculation unit 107 supplies information necessary to display a plurality of trajectories to be arranged in the three-dimensional display space and the thumbnail images at the decided arrangement positions to the image display control unit 109. Then, the image display control unit 109 controls the display of the GUI 100 where the trajectories corresponding to the metadata of the display target content are displayed in the three-dimensional space on the display 18 which is described by using, for example, FIGS. 3 to 14.

In step S54, in a case where it is determined that various flags do not exist in the thus obtained metadata, in step S56, the coordinate and time axis calculation unit 107 refers to the metadata of the displayed respective contents to set the characteristic parameters supplied from the display space control unit 106, converts the characteristic parameters into the coordinates in the three-dimensional display space (coordinate parameters) through a calculation, and decides the arrangement positions for the trajectories in the three-dimensional display space in accordance with the coordinate parameters. Then, the coordinate and time axis calculation unit 107 supplies information necessary to display a plurality of trajectories to be arranged in the three-dimensional display space at the decided positions to the image display control unit 109. Then, the image display control unit 109 controls the display of the GUI 100 where the trajectories corresponding to the metadata of the display target content are displayed in the three-dimensional space on the display 18, which is described by using, for example, FIG. 3.

After the processing in step S55 or S56, in step S57, on the basis of the operation input performed by the user which is supplied from the operation input obtaining unit 105, the display space control unit 106 determines whether or not the change in the setting of the coordinate in the three-dimensional space is instructed. In step S57, in a case where it is determined that the change in the setting of the coordinate in the three-dimensional space is instructed, the processing is returned to step S51, and this and subsequent processing will be repeated.

In step S57, in a case where it is determined that the change in the setting of the coordinate in the three-dimensional space is not instructed, in step S58, on the basis of the operation input performed by the user which is supplied from the operation input obtaining unit 105, the display space control unit 106 determines whether or not the change in the display target content is instructed. In step S58, in a case where it is determined that the change in the display target content is instructed, the processing is returned to step S52, and this and subsequent processing will be repeated.

In step S58, in a case where it is determined that the change in the display target content is not instructed, in step S59, on the basis of the operation input performed by the user which is supplied from the operation input obtaining unit 105, the display space control unit 106 determines whether or not one of the trajectories displayed on the GUI display screen is selected, that is, the selection of the content is instructed. In step S59, in a case where it is determined that the selection of the content is not instructed, the processing is advanced to step S62 which will be described below.

In step S59, in a case where it is determined that the selection of the content is instructed, in step S60, the display space control unit 106 assigns the selection content flag to the metadata of the content specified by the user.

In step S61, the display space control unit 106 supplies the information indicating the content specified by the user to the coordinate and time axis calculation unit 107. The coordinate and time axis calculation unit 107 generates information for changing the display of the trajectory corresponding to the content specified by the user to the highlight display, the display in a different color, or the like, for example, and supplies the information to the image display control unit 109. On the basis of the supplied information, the image display control unit 109 changes the display of the trajectory corresponding to the content specified by the user in the three-dimensional space of the GUI 100 displayed on the display 18.

In step S59, in a case where it is determined that the selection of the content is not instructed or after the processing in step S61, in step S62, on the basis of the operation input performed by the user which is supplied from the operation input obtaining unit 105, the display space control unit 106 determines whether or not the selection of the attention content is instructed. In step S62, in a case where it is determined that the selection of the attention content is not instructed, the processing is advanced to step S65 which will be described below.

In step S62, in a case where it is determined that the selection of the attention content is instructed, in step S63, the display space control unit 106 assigns the attention content flag to the metadata of the content specified as the attention content.

In step S64, the display space control unit 106 supplies the information indicating the attention content specified by the user to the coordinate and time axis calculation unit 107. The coordinate and time axis calculation unit 107 generates the information for further changing the display of the trajectory corresponding to the attention content specified by the user to the highlight display, the display in a different color, or the like, also with the selection content for example, and supplies the information to the image display control unit 109. On the basis of the supplied information, the image display control unit 109 changes the display of the trajectory corresponding to the attention content specified by the user in the three-dimensional space of the GUI 100 displayed on the display 18.

In step S62, in a case where it is determined that the selection of the attention content is not instructed or after the processing in step S64, in step S65, on the basis of the operation input performed by the user which is supplied from the operation input obtaining unit 105, the display space control unit 106 determines whether or not the selection of the starting point or the ending point of the supposedly matching part is received. In step S65, in a case where it is determined that the selection of the starting point or the ending point of the supposedly matching part is not received, the processing is advanced to step S68 which will be described below.

In step S65, in a case where it is determined that the selection of the starting point or the ending point of the supposedly matching part is received, in step S66, the display space control unit 106 assigns the starting point flag and the ending point flag indicating the starting point or the ending point to the frame corresponding to the coordinate specified by the user.

In step S67, the display space control unit 106 supplies the information indicating the starting point or the ending point of the supposedly matching part to the coordinate and time axis calculation unit 107. The coordinate and time axis calculation unit 107 computes the coordinates of the starting point or the ending point of the supposedly matching part specified by the user to be supplied to the image display control unit 109. On the basis of the supplied information, the image display control unit 109 adds a cross mark, for example, to the starting point or the ending point of the supposedly matching part specified by the user in the three-dimensional space of the GUI 100 displayed on the display 18 or changes the display of the trajectory in that section.

In step S65, in a case where it is determined that the selection of the starting point or the ending point of the supposedly matching part is not received or after the processing in step S67, in step S68, on the basis of the operation input performed by the user which is supplied from the operation input obtaining unit 105, the display space control unit 106 determines whether or not the display of the thumbnail image is instructed. In step S68, in a case where it is determined that the display of the thumbnail image is not instructed, the processing is advanced to step S71 which will be described below.

In step S68, in a case where it is determined that the display of the thumbnail image is instructed, in step S69, the display space control unit 106 assigns the thumbnail image display flag to the frame corresponding to the coordinate specified by the user.

In step S70, the display space control unit 106 supplies the information indicating the frame corresponding to the coordinate specified by the user to the coordinate and time axis calculation unit 107. Furthermore, the display space control unit 106 reads out the image in the frame from the video database 104 and decodes the image in the decoder 108 to be supplied to the image display control unit 109. The coordinate and time axis calculation unit 107 supplies the coordinate information specified by the user to the image display control unit 109. On the basis of the supplied information, the image display control unit 109 displays the thumbnail image based on the corresponding frame image data at the coordinate selected by the user in the three-dimensional space of the GUI 100 displayed on the display 18.

In step S68, in a case where it is determined that the display of the thumbnail image is not instructed or after the processing in step S70, in step S71, on the basis of the operation input performed by the user which is supplied from the operation input obtaining unit 105, the display space control unit 106 determines whether or not the reproduction of the motion picture is instructed. In step S71, in a case where it is determined that the reproduction of the motion picture is not instructed, the processing is advanced to step S75 which will be described below.

In step S71, in a case where it is determined that the reproduction of the motion picture is instructed, in step S72, on the basis of the operation input performed by the user which is supplied from the operation input obtaining unit 105, the display space control unit 106 determines whether or not the reproduction starting position is instructed.

In step S72, in a case where it is determined that the reproduction starting position is instructed, in step S73, the display space control unit 106 computes the content corresponding to the trajectory and the reproduction starting frame from the coordinate specified as the reproduction starting position of the trajectory which is specified by the user to be supplied to the coordinate and time axis calculation unit 107. Furthermore, the display space control unit 106 reads the image of the frame corresponding to the coordinate specified of the content and subsequent frames from the video database 104 and decodes the image in the decoder 108 to be supplied to the image display control unit 109. The coordinate and time axis calculation unit 107 displays a separate window and generate the information for reproducing and displaying the content corresponding to the specified trajectory from the specified reproduction starting position to be supplied to the image display control unit 109. On the basis of the supplied information, the image display control unit 109 displays a separate window in the GUI 100 which is displayed on the display 18 and performs the reproduction and display of the content corresponding to the specified trajectory from the reproduction starting position.

In step S72, in a case where it is determined that the reproduction starting position is not instructed, in step S74, the display space control unit 106 supplies the information indicating the content specified by the user to the coordinate and time axis calculation unit 107. Furthermore, the display space control unit 106 reads out the image of the content from the beginning from the video database 104 and decodes the image in the decoder 108 to be supplied to the image display control unit 109. The coordinate and time axis calculation unit 107 displays a separate window and generates the information for reproducing and displaying the content corresponding to the specified trajectory to be supplied to the image display control unit 109. On the basis of the supplied information, the image display control unit 109 displays a separate window in the GUI 100 which is displayed on the display 18 and performs the reproduction and display of the content corresponding to the specified trajectory.

In step S71, in a case where it is determined that the reproduction of the motion picture is not instructed or after the processing in step S73 or S74, in step S75, on the basis of the operation input performed by the user which is supplied from the operation input obtaining unit 105, the display space control unit 106 determines whether or not the operation end, the mode change, or the content additional recording is instructed.

In step S75, in a case where it is determined that the operation end, the mode change, or the content additional recording is not instructed, the processing is returned to step S57, and this and subsequent processing will be repeated. In step S75, in a case where it is determined that the operation end, the mode change, or the content additional recording is instructed, the processing is returned to step S20 of FIG. 30, and the processing is advanced to step S23.

Through such a processing, the trajectory mode described by using FIGS. 3 to 14 is executed, and in the virtual three-dimensional space in which the axes are composed by the characteristic parameters desired by the user, the trajectories based on the respective characteristic amounts are drawn. Thus, the user can easily find the combination of the contents in which at least parts of the contents are supposed to be matched with each other, or the like. It is possible to change the display of the trajectories of those contents, display the thumbnail images at the desired positions, and distinguish the range sandwiched by the starting point and the ending point of the supposedly matching part from other areas.

Next, with reference to flowcharts of FIGS. 33 and 34, the time line mode execution processing executed in step S22 of FIG. 33 will be described.

In step S101, on the basis of the operation input performed by the user which is supplied from the operation input obtaining unit 105, the display space control unit 106 determines whether or not the trajectory mode execution state is changed to the time line mode.

In step S101, in a case where it is determined that the trajectory mode execution state is changed to the time line mode, in step S102, the display space control unit 106 reads out the metadata of the contents to which the selection content flag and the attention content flag are assigned from the metadata database 102 to be supplied to the coordinate and time axis calculation unit 107. The coordinate and time axis calculation unit 107 obtains the metadata of the contents to which the selection content flag and the attention content flag are assigned.

In step S103, the coordinate and time axis calculation unit 107 extracts various flags from the thus obtained metadata.

In step S104, on the basis of the various flags, the coordinate and time axis calculation unit 107 generates information for displaying the underline and the thumbnail image data and supplies the information to the image display control unit 109. After the processing in step S104, the processing is advanced to step S108 which will be described below.

In step S101, in a case where it is determined that the trajectory mode execution state is not changed to the time line mode, in step S105, the display space control unit 106 determines which are selectable contents recorded in the video database 104 and displayed as the contents in the time line mode, and supplies information necessary to display the list of the selectable contents to the image display control unit 109. Then, the image display control unit 109 displays the list of the selectable contents on the display 18 of the GUI 100.

In step S106, on the basis of the operation input performed by the user which is supplied from the operation input obtaining unit 105, the display space control unit 106 receives the input of the selection contents and the attention content and supplies the information to the image display control unit 109.

In step S107, the display space control unit 106 assigns the selection content flag and the attention content flag to the metadata of the contents selected as the selection contents and the attention content by the user and reads out the metadata of these contents from the metadata database 102 to be supplied to the coordinate and time axis calculation unit 107. The coordinate and time axis calculation unit 107 obtains the metadata of the contents to which the selection content flag and the attention content flag are assigned and generate information for displaying the thumbnail image data corresponding to the selected contents to be supplied to the image display control unit 109.

After the processing in step S104 or S107, in step S108, the image display control unit 109 controls the display of the GUI display screen where the pieces of the thumbnail image data are arranged on the time line on the display 18 which is described by using, for example, FIGS. 15 to 17.

In step S109, on the basis of the operation input performed by the user which is supplied from the operation input obtaining unit 105, the display space control unit 106 determines whether or not new addition of the content for display is instructed. In step S109, in a case where it is determined that new addition of the content for display is not instructed, the processing is advanced to step S113 which will be described below.

In step S109, in a case where it is determined that new addition of the content for display is instructed, in step S110, the display space control unit 106 determines which is the content which is not currently displayed but is selectable as the content displayed in the time line mode among the contents recorded in the video database 104, and supplies the information necessary to display the list of the selectable contents to the image display control unit 109. Then, the image display control unit 109 displays the list of the selectable contents on the display 18 of the GUI 100.

In step S111, on the basis of the operation input performed by the user which is supplied from the operation input obtaining unit 105, the display space control unit 106 receives the input of the selected contents and supplies the information to the image display control unit 109.

In step S112, the display space control unit 106 assigns the selection content flag (or the attention content flag) to the metadata of the contents newly selected by the user, and also reads out the metadata of these contents from the metadata database 102 to be supplied to the coordinate and time axis calculation unit 107. The coordinate and time axis calculation unit 107 newly obtains the metadata of the selected contents and newly generates information for adding and displaying the thumbnail image data corresponding to the selected contents on the time line. The coordinate and time axis calculation unit 107 supplies the information to the image display control unit 109.

Then, the image display control unit 109 adds and displays the thumbnail images of the selected newly contents on the time line of the GUI display screen, which is described by using, for example, FIGS. 15 and 17.

In step S109, in a case where it is determined that new addition of the content for display is not instructed or after the processing in step S112, in step S113, on the basis of the operation input performed by the user which is supplied from the operation input obtaining unit 105, the display space control unit 106 determines whether or not the operation input for adding the display of the thumbnail images on the time line is received. A method of adding the display of the thumbnail images on the time line may also be, for example, adding the thumbnail images at a certain interval, displaying the thumbnail images immediately after the scene change, or adding the thumbnail images at a time specified by the user on the time line. In step S113, the operation input for adding the display of the thumbnail images on the time line is not received, the processing is advanced to step S116 which will be described below.

In step S113, in a case where it is determined that the operation input for adding the display of the thumbnail images on the time line is received, in step S114, the display space control unit 106 updates the metadata of the content corresponding to the instruction of the display of the thumbnail images by assigning the thumbnail image display flag to the frame added and displayed.

In step S115, the display space control unit 106 information supplies information for adding the display of predetermined thumbnail images on the time line to the coordinate and time axis calculation unit 107. Furthermore, the display space control unit 106 reads out the images in the frame added and displayed as the thumbnail images from the video database 104 and decodes the images in the decoder 108 to be supplied to the image display control unit 109. The coordinate and time axis calculation unit 107 computes the positions for displaying the thumbnail images on the time line and supplies the computation result to the image display control unit 109. On the basis of the supplied information, the image display control unit 109 adds and displays the thumbnail images based on the corresponding frame image data in the GUI 100 displayed on the display 18.

In step S113, in a case where it is determined that the operation input for adding the display of the thumbnail images on the time line is not received or after the processing in step S115, in step S116, on the basis of the operation input performed by the user which is supplied from the operation input obtaining unit 105, the display space control unit 106 determines whether or not the operation input for instructing the change of the underline length is received. In step S116, in a case where it is determined that the operation input for instructing the change of the underline length is not received, the processing is advanced to step S119 which will be described below.

In step S116, in a case where it is determined that the operation input for instructing the change of the underline length is received, in step S117, on the basis of the operation input performed by the user, the display space control unit 106 changes the frames to which the starting point flag and the ending point flag are assigned in the metadata of the content corresponding to the operation input for instructing the change of the underline length, and supplies the information to the coordinate and time axis calculation unit 107. Furthermore, the display space control unit 106 reads out the image in the frame newly specified as the starting point or the ending point from the video database 104 and decodes the image in the decoder 108 to be supplied to the image display control unit 109.

In step S118, on the basis of the starting point and the ending point specified by the user, the coordinate and time axis calculation unit 107 executes a computation for changing the length of the underline on the screen and supplies the result to the image display control unit 109. On the basis of the supplied information, the image display control unit 109 changes the length of the underline displayed on the screen and also displays the thumbnail image at a point corresponding to the frame newly specified as the starting point or the ending point.

In step S116, in a case where it is determined that the operation input for instructing the change of the underline length is not received or after the processing in step S118, in step S119, on the basis of the operation input performed by the user which is supplied from the operation input obtaining unit 105, the display space control unit 106 determines whether or not the operation end, the mode change, or the content additional recording is instructed.

In step S119, in a case where it is determined that the operation end, the mode change, or the content additional recording is not instructed, the processing is returned to step S108, and this and subsequent processing will be repeated. In step S119, in a case where it is determined that the operation end, the mode change, or the content additional recording is instructed, the processing is ended.

Through such a processing, the time line mode is executed in the manner described by using FIGS. 15 to 20, and the user can easily recognize that the matching parts of the plurality of contents are located at which parts of the respective contents and easily recognize the relation among those matching parts. Therefore, the user can obtain information, for example, for classifying and sorting out a large number of contents.

In addition, although not described in the flowchart of FIGS. 33 and 34, as illustrated in FIGS. 18 to 20, the motion picture image may be displayed in the separate window also in the time line mode of course. The processing in that case is basically similar to the processing described by using steps S71 to S74 of FIG. 32.

In this manner, in the image processing apparatus 11, for example, in a case where a motion picture which is not preferable in terms of the copy right management is wished to be found on the motion picture sharing site or in order to detect the redundant uploads, without checking the beginning of the plurality of contents or the image at the scene change, by viewing the trajectory of the motion picture, it is possible to display the GUI display screen which supports the selection as to whether or not there is a possibility of matching.

For example, in a case where a comparison between the numeric values of the parameter is performed to find out whether or not the substances of two contents are matched with each other, as described above, a content is distinguished as a different content which has only the deviated luminance information. When the error range of the parameter is set wide to avoid such a situation, many erroneous detections are caused. In contrast to this, in particular, in the trajectory mode, even though the contents are the same in substances, due to the repetition of the image processings such as the editing, the image size change, and the compression and expansion, even in a case where the parameters of the image are varied, it is possible for the user to easily find the parts in which the substances are supposed to be matched with each other. Also, on the other hand, even when the tendencies of the parameters are similar to each other, in the trajectory mode, although the setting of the three-dimensional coordinate axis is changed and the trajectory mode and the time line mode are repeated to display the thumbnail image at the desired position, for example, in a case where the contents are actually different from each other, it is possible for the user to easily distinguish the contents.

In addition, in a case where the number of contents necessary to be managed is large, there is a possibility that the same contents are redundantly recorded and the content is edited so that the number of contents to be managed becomes extremely large including the material contents before the editing and the contents after the editing. For example, in a case where a comparison between the numeric values of the parameter is performed to find out whether or not the substances of two contents are matched with each other, the matching is checked through all the combinations of the numeric values, and the calculation amount is extremely large. In contrast to this, in the image processing apparatus 11, by referring to the GUI display screen in the trajectory mode and the time line mode, the plurality of contents are compared at once to check the matching parts of the contents, and the contents can be easily classified and sorted out.

In addition, with the use of the image processing apparatus 11, by referring to the display in the time line mode, it is possible to easily provide such a service that the processing of putting a link on the contents used as the editing materials, or the like, is performed with respect to the motion picture which is the base of the respective scenes constituting the contents after the editing and the user can alternately view the associated contents.

The above-mentioned series of processing can also be executed by software. The software is installed from a recording medium, for example, to a computer in which a program constituting the software is incorporated in dedicated use hardware or a general use personal computer which can execute various functions by installing various programs.

This recording medium is composed of a removal disc which is mounted to the drive 14 of FIG. 1, which is distributed to provide the program to the user other than the computer such as, for example, a magnet disc (including a flexible disc), an optical disc (CD-ROM (Compact Disc-Read Only Memory), a DVD (including Digital Versatile Disc)), or an opto-magnitic disc (including MD (Mini-Disc) (trademark)) on which the program is recorded or package media composed of a semiconductor memory or the like.

In addition, in the present specification, the processing may of course be performed in the state order of steps describing the programs recorded on the recording medium in a time series manner, and also the processing is not necessarily performed in the time series manner but may be performed in a parallel manner or individually.

It should be noted that in the present specification, the system represents an entire apparatus composed of a plurality of apparatuses.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus, comprising:
reception means adapted to receive a parameter in respective frames which constitute a motion picture image;
generation means adapted to generate from the parameter received by the reception means, trajectory information for drawing a trajectory where the parameter is used for a coordinate while the parameter is used for a spatial axis of a virtual space; and
display control means adapted to display the trajectory within the virtual space on the basis of the trajectory information generated by the generation means.

2. The image processing apparatus according to claim 1, further comprising:
operation means adapted to receive an operation input from a user,
wherein on the basis of the operation input performed by the user which is input through the operation means, in a case where the parameter specification is changed, the generation means newly generates the trajectory information while the newly specified parameter is used for the spatial axis of the virtual space.

3. The image processing apparatus according to claim 1, further comprising:
image generation means adapted to generate a thumbnail image of a frame constituting the motion picture image; and
control means adapted to assign a display flag to a part of a frame corresponding to a predetermined position of the trajectory of metadata in a case where an operation input for displaying the thumbnail image of the frame corresponding to the predetermined position of the trajectory displayed in the virtual space which is performed by the operation means is received,
wherein the display control means displays the thumbnail image generated by the image generation means on the predetermined position of the trajectory while following the display flag assigned by the control means.

4. The image processing apparatus according to claim 1, further comprising:
control means adapted to assign, in a case where an operation input for selecting a trajectory through the operation means is received, a display flag to a part of a motion picture image corresponding to the selected trajectory,
wherein the display control means displays the selected trajectory so as to be distinguishable from another trajectory while following the display flag assigned by the control means.

5. The image processing apparatus according to claim 1, further comprising:
control means adapted to assign, in a case where an operation input for selecting a trajectory through the operation means is received, a starting point flag and an ending point flag to a part of a frame corresponding to a starting point and a part of a frame corresponding to an end point in the selected area, respectively,
wherein the display control means displays the selected area so as to be distinguishable from another area while following the starting point flag and the ending point flag assigned by the control means.

6. The image processing apparatus according to claim 1, further comprising:
image generation means adapted to generate a thumbnail image of a frame constituting the motion picture image,
wherein the generation means generates display information for displaying the thumbnail image generated by the image generation means along a time line, and
wherein the display control means displays the thumbnail image along the time line on the basis of the display information generated by the generation means.

7. The image processing apparatus according to claim 6, wherein in a case where the operation input performed by a user which is input through the operation means is received, the display control means displays one of the trajectory in the virtual space and the thumbnail image along the time line.

8. The image processing apparatus according to claim 7, further comprising:
control means adapted to assign, in a case where an operation input for selecting a trajectory through the operation means is received, a selection flag to a part of a motion picture image corresponding to the selected trajectory,
wherein the display control means displays the thumbnail image along the time line while following the selection flag assigned by the control means.

9. The image processing apparatus according to claim 7, further comprising:
control means adapted to assign, in a case where an operation input for selecting a trajectory through the operation means is received, a starting point flag and an ending point flag to a part of a frame corresponding to a starting point and a part of a frame corresponding to an end point in the selected area, respectively,
wherein in a case where an operation input for displaying the thumbnail image along the time line through the operation means is received, the display control means displays the thumbnail image in a state where positions of the frames to which the starting point flag and the ending point flag are assigned are recognizable.

10. The image processing apparatus according to claim 6, further comprising:
control means adapted to assign a thumbnail image display flag at a part of a frame corresponding to the position on the time line in a case where an operation input for selecting the position on the time line through the operation means is received from a user who makes a reference to the display of the thumbnail image along the time line,
wherein the image generation means generates the thumbnail image of the frame corresponding to the position on the time line, and
wherein the display control means displays the thumbnail image generated by the image generation means at the position on the time line.

11. The image processing apparatus according to claim 1,
wherein the parameter includes three different parameters, and
wherein the virtual space is a three-dimensional space.

12. The image processing apparatus according to claim 1, wherein the parameter includes luminance.

13. An image processing method, comprising the steps of:
receiving a parameter in respective frames which constitute a motion picture image;
generating from the received parameter, trajectory information for drawing a trajectory where the parameter is used for a coordinate while the parameter is used for a spatial axis of a virtual space; and
displaying the trajectory within the virtual space on the basis of the generated trajectory information.

14. An image processing apparatus, comprising:
a reception unit adapted to receive a parameter in respective frames which constitute a motion picture image;
a generation unit adapted to generate from the parameter received by the reception unit, trajectory information for drawing a trajectory where the parameter is used for a coordinate while the parameter is used for a spatial axis of a virtual space; and
a display control unit adapted to display the trajectory within the virtual space on the basis of the trajectory information generated by the generation unit.
